(19) United States
(12) Patent Application Publication
(10) Pub. No.: US 2025/0299408 A1
(43) Pub. Date: Sep. 25, 2025

(54) ANIMATION GENERATION METHOD AND APPARATUS FOR AVATAR, ELECTRONIC DEVICE, COMPUTER PROGRAM PRODUCT, AND COMPUTER-READABLE STORAGE MEDIUM

(71) Applicant: Tencent Technology (Shenzhen) Company Limited, Shenzhen (CN)

(72) Inventor: Ying ZHAO, Shenzhen (CN)

(73) Assignee: Tencent Technology (Shenzhen) Company Limited, Shenzhen (CN)

(21) Appl. No.: 19/230,358

(22) Filed: Jun. 6, 2025

Related U.S. Application Data
(63) Continuation of application No. PCT/CN2024/084579, filed on Mar. 28, 2024.

(30) Foreign Application Priority Data
May 26, 2023 (CN) 202310613703.0

(51) Int. Cl. G06T 13/40; G06T 17/20; G06V 40/16; G06V 40/20

(52) U.S. Cl. CPC G06T 13/40; G06T 17/20; G06V 40/176; G06V 40/23

(57) ABSTRACT

An avatar animation generation method includes obtaining video data of a physical object; extracting posture information of the object based on the video data, wherein the posture information indicates a body posture and an expression posture presented by the object in the video data; performing 3D reconstruction on the object based on the posture information to obtain motion data representing a body motion of an avatar and expression data representing a facial expression of the avatar, wherein the motion data is obtained through reconstruction based on the body posture, and wherein the expression data is obtained through reconstruction based on the expression posture; and obtaining animation data of the avatar through synthesis based on an appearance resource of the avatar, the motion data, and the expression data, wherein the animation data indicates that the avatar wears the appearance resource, presents the facial expression, and performs the body motion.

### CROSS-REFERENCE TO RELATED APPLICATIONS

This application is a continuation application of International Application No. PCT/CN2024/084579 filed on Mar. 28, 2024, which claims priority to Chinese Patent Application No. 202310613703.0 filed with the China National Intellectual Property Administration on May 26, 2023, the disclosures of each being incorporated by reference herein in their entireties.

### FIELD

The disclosure relates to the field of computer technologies, and to an animation generation method and apparatus for an avatar, an electronic device, a computer program product, and a computer-readable storage medium.

### BACKGROUND

With development of computer technologies, avatars are increasingly widely used in livestreaming, film and television, animation, gaming, virtual social networking, human-computer interaction, and other aspects. How to precisely drive an avatar to generate a smooth animation is of great importance to rendering performance of the avatar.

A real person performs performance based on a play script, and a motion capture device captures body motions and facial expressions of the real person, and converts captured data into 3D motion data and 3D expression data of an avatar, to drive the avatar to perform body motions and facial expressions similar to those of the real person at consecutive moments.

Due to high costs of the motion capture device, the foregoing motion capture-based animation generation mode is applied only to professional film and television production and cannot be popularized in general scenarios such as livestreaming and gaming, and efficiency of animation generation for an avatar is low.

### SUMMARY

According to an aspect of the disclosure, an avatar animation generation method, performed by an electronic device includes, obtaining video data of a physical object; extracting posture information of the physical object based on the video data, wherein the posture information indicates a body posture and an expression posture presented by the physical object in the video data; performing 3D reconstruction on the physical object based on the posture information to obtain motion data representing a body motion of an avatar and expression data representing a facial expression of the avatar, wherein the motion data is obtained through reconstruction based on the body posture, and wherein the expression data is obtained through reconstruction based on the expression posture; and obtaining animation data of the avatar through synthesis based on an appearance resource of the avatar, the motion data, and the expression data, wherein the animation data indicates that the avatar wears the appearance resource, presents the facial expression, and performs the body motion.

According to an aspect of the disclosure, an avatar animation generation apparatus includes at least one memory configured to store computer program code; and at least one processor configured to read the program code and operate as instructed by the program code, the program code including obtaining code configured to cause at least one of the at least one processor to obtain video data of a physical object; extraction code configured to cause at least one of the at least one processor to extract posture information of the physical object based on the video data, wherein the posture information indicates a body posture and an expression posture presented by the physical object in the video data; reconstruction code configured to cause at least one of the at least one processor to perform 3D reconstruction on the physical object based on the posture information to obtain motion data representing a body motion of an avatar and expression data representing a facial expression of the avatar, wherein the motion data is obtained through reconstruction based on the body posture, and wherein the expression data is obtained through reconstruction based on the expression posture; and synthesis code configured to cause at least one of the at least one processor to obtain animation data of the avatar through synthesis based on an appearance resource of the avatar, the motion data, and the expression data, wherein the animation data indicates that the avatar wears the appearance resource, presents the facial expression, and performs the body motion.

According to an aspect of the disclosure, a non-transitory computer-readable storage medium, storing computer code which, when executed by at least one processor, causes the at least one processor to at least obtain video data of a physical object; extract posture information of the physical object based on the video data, wherein the posture information indicates a body posture and an expression posture presented by the physical object in the video data; perform 3D reconstruction on the physical object based on the posture information to obtain motion data representing a body motion of an avatar and expression data representing a facial expression of the avatar, wherein the motion data is obtained through reconstruction based on the body posture, and wherein the expression data is obtained through reconstruction based on the expression posture; and obtain animation data of the avatar through synthesis based on an appearance resource of the avatar, the motion data, and the expression data, wherein the animation data indicates that the avatar wears the appearance resource, presents the facial expression, and performs the body motion.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. One of ordinary skill would understand that aspects of some embodiments may be combined together or implemented alone.

FIG. 1 is a schematic diagram of some embodiments of an animation generation method for an avatar according to some embodiments.

FIG. 2 is a flowchart of an animation generation method for an avatar according to some embodiments.

FIG. 3 is a flowchart of an animation generation method for an avatar according to some embodiments.

FIG. 4 is a flowchart of a principle of an animation generation solution for an avatar according to some embodiments.

FIG. 5 is a diagram of a principle of video format conversion according to some embodiments.

FIG. 6 is a diagram of a principle of a skeletal skinning manner according to some embodiments.

FIG. 7 is a diagram of a principle of an animation driving process according to some embodiments.

FIG. 8 is a flowchart of a principle of an animation generation solution according to some embodiments.

FIG. 9 is a diagram of a logical principle of an animation generation solution according to some embodiments.

FIG. 10 is a schematic diagram of a structure of an animation generation apparatus for an avatar according to some embodiments.

FIG. 11 is a schematic diagram of a structure of an electronic device according to some embodiments.

FIG. 12 is a schematic diagram of a structure of another electronic device according to some embodiments.

### DESCRIPTION OF EMBODIMENTS

To make the objectives, technical solutions, and advantages clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope.

In the following descriptions, related “some embodiments” describe a subset of all possible embodiments. It may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms “first”, “second”, and the like in some embodiments are intended for distinguishing between same items or similar items that have the same effects and functions. The “first”, “second”, and “nth” do not have a dependency relationship in logic or time sequence, and a quantity and an execution order thereof are not limited.

In some embodiments, the term “at least one” means one or more, and “a plurality of” means two or more. For example, a plurality of skeletal components are two or more skeletal components.

In some embodiments, the term “including at least one of A or B” involves the following several cases: including only A, including only B, and including both A and B.

When applied to a product or technology with a method in embodiments of this application, user-related information (including but not limited to device information, personal information, and behavioral information of a user, and the like), data (including but not limited to data for analysis, stored data, displayed data, and the like), and signals in some embodiments are used under permission, consent, and authorization by users or full authorization by all parties. Collection, use, and processing of related information, data, and signals should comply with related laws, regulations, and standards in related countries and regions. For example, all video data of a physical object in some embodiments is obtained with full authorization.

Artificial intelligence (AI) involves a theory, a method, a technology, and an application system that use a digital computer or a machine controlled by a digital computer to simulate, extend, and expand human intelligence, perceive an environment, obtain knowledge, and use the knowledge to obtain an optimal result. AI is a comprehensive technology in computer science and attempts to understand the essence of intelligence and produce a new intelligent machine that can react in a manner similar to human intelligence. AI is to study design principles and implementation methods of various intelligent machines, to enable the machines to have functions of perception, inference, and decision-making.

The AI technology is a comprehensive discipline, and relates to a wide range of fields including both hardware-level technologies and software-level technologies. Basic AI technologies may include technologies such as a sensor, a dedicated AI chip, cloud computing, distributed storage, a big data processing technology, an operating/interaction system, and electromechanical integration. AI software technologies may include several major directions such as a computer vision (CV) technology, a speech processing technology, a natural language processing technology, machine learning/deep learning, autonomous driving, and intelligent traffic.

Enabling a computer to listen, see, speak, and feel is a future development direction of human-computer interaction, and the CV technology becomes one of the most promising human-computer interaction means in the future. CV is a science that studies how to use a machine to “see”, and that uses a camera and a computer to replace human eyes to perform machine vision such as recognition and measurement on a target, and further perform graphics processing, so that the computer processes the target into an image for human eyes to observe, or an image transmitted to an instrument for detection. As a scientific discipline, CV studies related theories and technologies and attempts to establish an AI system that can obtain information from images or multidimensional data. The CV technology may include image processing, image recognition, image semantic comprehension, image retrieval, optical character recognition (OCR), video processing, video semantic comprehension, video content/behavior recognition, a 3D technology, 3D object reconstruction, virtual reality (VR), augmented reality (AR), simultaneous localization and mapping, autonomous driving, and intelligent traffic.

With research and development of AI technologies, AI technologies have been studied and applied in many fields, for example, common fields such as smart household, smart wearable devices, virtual assistants, smart speakers, smart marketing, self-driving, autonomous driving, uncrewed aerial vehicles, robots, smart healthcare, intelligent customer service, vehicle-to-everything, and intelligent traffic. It is believed that AI technologies are to be applied in more fields and play an increasingly important part with development of technologies.

Solutions provided in some embodiments relate to the CV technology of AI, and to an application of producing a 3D animation of an avatar by using the CV technology. This is described in detail in the following embodiments.

Terms in some embodiments are described below.

Avatar: It is a movable object in a virtual world. An avatar is a virtual and personified digital character in a virtual world, for example, a virtual person, an animated person, or a virtual character. The avatar may be a 3D model. The 3D model may be a 3D character constructed based on a 3D human skeleton technology. In some embodiments, the avatar may be implemented by a 2.5-dimensional (2.5D) or two-dimensional (2D) model. This is not limited. A 3D model of an avatar may be produced by using 3D computer graphics software Miku Dance, the Unity engine, the Unreal Engine 4 (UE4) engine, or the like. A 2D model of an avatar may be produced by using 2D computer graphics software Live2D. A dimension of an avatar is not limited herein.

Metaverse: It is also referred to as a meta universe, a meta space, and a virtual space, and is a 3D virtual world network focusing on social links. The metaverse relates to a persistent and decentralized online 3D virtual environment.

Digital human: It is an avatar produced by performing 3D modeling on a human body by using an information science method to simulate the human body. A digital human is a digital character that is created by using a digital technology and that is similar to a human image. Digital humans are widely applied to video creation, livestreaming, industry broadcasting, social and entertainment, voice prompting, and other scenarios. For example, a digital human may serve as a virtual livestreaming host or an avatar. The digital human is also referred to as a virtual person, a virtual digital human, or the like.

Virtual streamer: It is a streamer that posts videos on a video website by using an avatar, for example, a virtual YouTuber (VTuber) or a virtual uploader (VUP). The virtual streamer performs activities on a video website or a social platform with an original virtual personality and image. The virtual streamer may implement human-computer interaction in various forms, such as broadcasting, performing, livestreaming, and conversations.

Person behind: It is a person who performs behind or controls a virtual streamer during livestreaming. For example, a body motion and a facial expression of the person behind are captured by using an optical motion capture system based on a sensor installed on the head and a limb of the person behind, and motion data is synchronized to the virtual streamer. Real-time interaction between the virtual streamer and an audience watching the livestreaming can be implemented based on a real-time motion capture mechanism.

Motion capture (MoCap): A sensor is deployed on a key part of a moving object or a real person. A motion capture system captures a position of the sensor, and the position of the sensor is processed by a computer to obtain motion data of 3D spatial coordinates. After being recognized by a computer, the motion data may be applied to animation production, gait analysis, biomechanics, ergonomics, and other fields. A common motion capture device includes a motion capture suit.

Frame interpolation: It is a motion estimation and motion compensation method that can increase a quantity of animation frames of an animation clip when a quantity of frames is insufficient, to make an animation coherent. For example, a new animation frame is inserted between every two original animation frames of the animation clip, to supplement an intermediate change status of a body motion or a facial expression in the two animation frames by using the new animation frame.

Game engine: It includes some editable computer game systems that have been written or core components of some interactive real-time image applications. These systems provide a game designer with various tools for writing a game, to enable the game designer to and quickly create a game program without starting from scratch. The game engine includes the following systems: an animation engine, a rendering engine, a physics engine, a collision detection system, a sound effect, a scripting engine, AI, a network engine, and scene management.

UE4 engine: It is an industry-leading 3A-level game engine developed by EPIC, a gaming company, and is a complete game development platform oriented toward a next-generation game console and a DirectX 9-based personal computer. The UE4 engine provides a large number of core technologies, data generation tools, and basic support used by a game developer. The UE4 engine provides high efficiency, multi-functionality, direct preview of development effects, and other capabilities. A programming feature of the UE4 engine lies in visual blueprint programming. The UE4 engine supports running on a plurality of platforms such as a game console, a personal computer, and a mobile phone, and is applicable to game development, film and television production, animation production, and other fields.

Editor: It is a visual operation tool of the UE4 engine. The editor integrates functions of UE4 on a visual interface to enable a user to quickly edit a scene, and integrates various tools. The editor is a bridge for a user to use the engine.

Plug-in: In the UE4 engine, a plug-in is a code and data collection that can be enabled or disabled by a developer in the editor in a per-item manner. The plug-in may be configured to add a runtime gameplay function, modify a built-in engine function (or add a new function), create a file type, and extend functions of the editor by using a new menu, a toolbar command, and a sub-mode. Many UE4 subsystems may be obtained through extension by using the plug-in.

Rendering engine: In the field of image technologies, a rendering engine renders a 3D model obtained by modeling an avatar into a 2D image, so that 3D effects of the 3D model are still retained in the 2D image. The rendering process from the 3D model to the 2D image is implemented by the rendering engine driving a rendering pipeline in a graphics processing unit (GPU), so that the avatar indicated by the 3D model is visually displayed on a display.

GPU: It is a dedicated chip used for graphics and image processing in a modern personal computer, a server, a mobile device, a game console, or the like.

Graphics application programming interface (GAPI): A process of a central processing unit (CPU) communicating with a GPU is performed based on a GAPI of a standard. Mainstream GAPIs include OpenGL, OpenGL ES, DirectX, Metal, Vulkan, and the like. A GPU manufacturer implements interfaces of some specifications when producing a GPU, and during graphics development, the GPU may be invoked according to a method defined by the interface.

Draw call (DC) command: A type of DC command that may be used by a CPU to instruct a GPU to perform a rendering operation may be provided in a graphics API. For example, the DrawIndexedPrimitive command in DirectX and the glDrawElement command in OpenGL are both DC commands supported in a corresponding graphics API.

Rendering pipeline: It is a graphics rendering process running in a GPU. An image rendering process usually involves the following types of rendering pipelines: a vertex shader (VS), a rasterizer, and a pixel shader (PS). Code can be written in a shader to control the GPU to perform drawing rendering on a rendering component.

VS: It is a part of the GPU rendering pipeline and is an image processing unit for enhancing 3D effects. The VS has a programmable characteristic that allows a developer to adjust an effect by using a new instruction. Each vertex is defined by a data structure. A basic attribute of the vertex includes vertex coordinates in three directions: X, Y, and Z. Vertex attributes may further include a color, an initial path, a material, a light feature, and the like. A program performs calculation on each vertex of a 3D model in a per-vertex manner based on code, and outputs a result to a next stage.

Rasterizer: It is a non-codable part of the GPU rendering pipeline. A program automatically assembles a result output by the VS or a geometry shader into a triangle, rasterizes the triangle into discrete pixels based on a configuration, and outputs the discrete pixels to the PS.

PS: It may be implemented as a fragment shader (FS), and is a part of the GPU rendering pipeline. After a vertex of a model is transformed and rasterized, a color may be added. An FS/PS filling algorithm is intended for each pixel on a screen: A program performs shading calculation on a rasterized pixel based on code, and outputs the rasterized pixel to a frame buffer after testing succeeds, to complete a rendering pipeline process.

Frame buffer: It is a memory buffer that includes data representing all pixels in a complete frame of game picture, and is configured to store an image that is under synthesis or being displayed in a computer system. The frame buffer is a bitmap that is included in some random access memories (RAMs) and that drives a display of a computer. A kernel of a modern graphics card includes a frame buffer circuit. The frame buffer circuit converts a bitmap in a memory into a picture signal that can be displayed on a display.

Z-buffer (for example, depth buffer): It is a memory, in a frame buffer, that is configured to store depth information of all pixels is referred to as a Z-buffer or a depth buffer. During rendering of an object in a 3D virtual scene, a depth (for example, a Z coordinate) of each generated pixel is stored in the Z-buffer. The Z-buffer may be organized into an X-Y 2D array that stores a depth of each screen pixel. In the Z-buffer, depth sorting may be performed on points of a plurality of objects appearing at the same pixel. A GPU performs calculation based on the depth sorting recorded in the Z-buffer, to achieve a depth perception effect that a closer object blocks a farther object.

Color buffer: A memory, in a frame buffer, that is configured to store color information of all pixels is referred to as a color buffer. During rendering of an object in a 3D virtual scene, all points that pass depth testing are assembled by a rasterizer into discrete pixels, and a color of each discrete pixel is stored in the color buffer. Color vectors of pixels are in different formats based on different color modes.

Texture mapping (for example, UV mapping): U and V are coordinates of a picture in a horizontal direction and a vertical direction of a display respectively, and values usually range from 0 to 1. For example, the U coordinate represents a width of a U^{th} pixel/picture in the horizontal direction, and the V coordinate represents a height of a V^{th} pixel/picture in the vertical direction. The UV coordinates (for example, texture coordinates) are a basis for mapping a UV mapping of an avatar to a surface of a 3D model of the avatar. The UV coordinates define position information of each pixel on a picture. The pixels and vertices on the surface of the 3D model are associated with each other, to determine a position of a pixel, on the picture, to which a surface texture is to be projected. The UV mapping can precisely map each pixel on the picture to the surface of the 3D model, and smooth image interpolation is performed at a gap position between points by software. This is the UV mapping. To properly distribute a UV texture of the 3D model on a 2D canvas, a 3D surface is properly tiled on the 2D canvas. This process is referred to as UV unwrapping.

Point cloud: It is a set of discrete points in irregular distribution in space that express a spatial structure and a surface attribute of a 3D object or a 3D scene. Point clouds may be classified into different types based on different classification standards. For example, the point clouds are classified into a dense point cloud and a sparse point cloud based on manners of obtaining the point clouds. For another example, the point clouds are classified into a static point cloud and a dynamic point cloud based on timing types of the point clouds.

Point cloud data: Geometric information and attribute information of points in a point cloud constitute the point cloud data. The geometric information may also be referred to as 3D position information. Geometric information of a point in the point cloud is spatial coordinates (x, y, z) of the point, and includes coordinate values of the point in all coordinate axis directions of a 3D coordinate system, for example, a coordinate value x in an X-axis direction, a coordinate value y in a Y-axis direction, and a coordinate value z in a Z-axis direction. Attribute information of a point in the point cloud includes at least one of the following: color information, material information, or laser reflection intensity information (also referred to as reflectivity). The points in the point cloud have the same quantity of pieces of attribute information. For example, each point in the point cloud has two types of attribute information: color information and laser reflection intensity information. For another example, each point in the point cloud has three types of attribute information: color information, material information, and laser reflection intensity information.

3D reconstruction: Establishing, for a 3D object, a mathematical model for computer representation and processing is a basis for processing, performing operations on, and analyzing properties of the 3D object in a computer environment, and is also a key technology for establishing VR that expresses an objective world on a computer. For example, 3D reconstruction of an avatar includes reconstructing a 3D model of the avatar. The reconstruction involves two dimensions: 3D skeletal reconstruction and 3D facial reconstruction.

Mesh: A fundamental element in computer graphics is referred to as a mesh, and a common mesh is a triangular patch mesh. For a 3D model, the 3D model is formed by stitching polygons, and a complex polygon is actually formed by stitching a plurality of triangular facets. An outer surface of a 3D model includes a plurality of triangular facets connected to each other. In 3D space, a collection of points constituting these triangular facets and edges of triangles is a mesh. A point of a triangular facet in the mesh is referred to as a vertex of the 3D model.

Animation: It records a state of an object at a moment by using a time frame, and then performs switching in an order at a time interval. An animation principle of all software is similar to this. In the Unity engine, a behavior (also referred to as an animation behavior) of each avatar is controlled by an animator controller to which the avatar belongs.

Skeletal component: It is referred to as “skeleton” for short, and is a concept abstracted from an animation algorithm. A physical meaning of a skeletal component of an avatar is similar to that of a human skeleton. The human skeleton is simulated by using the skeletal component, to control an animation behavior of a 3D model of the avatar.

Skeletal animation: It is a type of model animation different from a vertex animation. Two types of model animations are available: the vertex animation and the skeletal animation. In the skeletal animation, a 3D model has a skeletal structure including “skeletal components” connected to each other. A person skilled in the art pre-produces an animation resource, and controls a position change of a skeletal component by using the animation resource, to indirectly drive a position change of a mesh vertex bound to the skeletal component, and generate animation data for the 3D model. The skeletal animation is applicable to animation generation with many complex meshes, for example, running and jumping of an avatar.

Skeletal skin: After a skeletal component is selected, mesh vertices of a 3D model that are driven by the skeletal component, and a weight during driving may be specified.

Vertex animation: It is a type of model animation different from a skeletal animation. Two types of model animations are available: the vertex animation and the skeletal animation. The vertex animation is also referred to as a per-vertex animation. An operation is performed on each vertex of a 3D model in a VS to produce an animation effect. Each frame of animation is actually a “snapshot” in which the 3D model presents a posture. An animation engine can achieve a smooth animation effect through frame interpolation between different animation frames. The vertex animation stretches each triangle in a mesh of the 3D model to generate a more natural motion (or expression). Vertex animations are classified into a morph animation and a pose animation.

Morph animation: A person skilled in the art adds an animation to a vertex of a mesh. After motion data is exported out of a game engine, the motion data can tell the engine how to move the vertex during running. This technology can produce any conceivable mesh deformation. This is a data-intensive technology because motion information of each vertex that changes with time may be stored. This technology is rarely used in real-time games.

Pose animation: It is applied to some real-time engines. In this method, a person skilled in the art also moves a vertex of a mesh, but produces only a small quantity of blender shapes. Two or more shapes may be blended during running to generate an animation. A position of each vertex is obtained through linear interpolation on a position of a vertex of each blender shape.

NEON instruction set: It is a 128-bit single instruction multiple data (SIMD) extension structure applicable to an ARM Cortex-A series processor.

Universal serial bus (USB) external camera: It is an external camera connected to a USB interface, and is recognized by a hardware platform based on the USB Video Class (UVC) protocol.

UVC protocol: It is a protocol standard jointly defined by Microsoft and several other device manufacturers for a USB video capture device (for example, a USB external camera), and has currently become one of USB org standards. The UVC protocol is one of device specifications among USB specification protocols, and is a unified data exchange specification for video devices based on USB interfaces.

A technical concept of some embodiments are described below.

With rapid development of technologies such as 3D modeling, VR, AR, and metaverse in the CV field, avatars are increasingly widely used in livestreaming, film and television, animation, gaming, virtual social networking, human-computer interaction, and other aspects.

A user has an increasingly high visual requirement for image quality (for example, picture quality, definition, and resolution). To make an avatar lifelike and vivid during an animation, how to precisely drive the avatar to generate a smooth animation is of great importance to rendering performance of the avatar. The animation generation herein includes two meanings. One meaning is to generate a body motion of the avatar, and the other meaning is to generate a facial expression of the avatar. The body motion and the facial expression are combined to form an animation behavior of the avatar.

A livestreaming scenario is used as an example. An avatar serves as a streamer for broadcasting or conversations. To improve a realistic rendering effect of the avatar, animation generation for the avatar is involved. In a video creation scenario, for example, in a scenario of creating a to-be-posted video of a virtual streamer or creating a digital human video, to improve a realistic rendering effect of an avatar, animation generation for the avatar is also involved.

During animation production for an avatar, the following animation generation means are used:

1. Driving by a human body: A physical behavior feature of a real person is captured by using a camera, to drive a skeletal component of a 3D model of an avatar, so that the 3D model can simulate a behavior of the real person.

In the foregoing manner of driving by a human body, offline data may be input, or a pre-recorded video may be input, to parse the physical behavior feature of the real person. Then position information and rotation information (collectively referred to as pose data) of each joint of the 3D model of the avatar are further extracted, and the avatar is driven, based on the pose data of each joint, to perform an animation behavior. Due to limitations of a calculation amount and complexity, real-time performance is poor, and the foregoing manner cannot be applied to the UE4 engine for high-quality animation generation. Efficiency of animation generation is low, real-time performance of animation generation is poor, and a requirement for animation generation with high real-time performance cannot be met.

2. Driving by a digital human: The UE4 engine has a digital human system. In the digital human system, a digital human is preset as a plurality of digital human components, and the preset digital human components are driven by preset digital human motion data.

In the foregoing manner of driving by a digital human, the digital human system of the UE4 engine is native. All replaceable digital human components are preconfigured, and a person skilled in the art cannot customize an appearance resource of the digital human, but can only select an appearance resource from an existing component library. In the UE4 engine, driving by the digital human is also performed offline, and only some driving animations can be preset to control a 3D model to perform an animation. Efficiency of animation generation is low, real-time performance of animation generation is poor, and a requirement for high real-time performance of animation generation cannot be met.

3. Skeletal animation: It is a main manner of making an avatar move in a game. A person skilled in the art performs skeleton production and skin binding, and then produces key frame animation data of the avatar, to make the avatar move based on a predetermined behavior track.

In the foregoing skeletal animation manner, a person skilled in the art may pre-produce a series of key frame animation data, to control the avatar to move based on the predetermined behavior track. Because an animation generation process is also performed offline, efficiency of animation generation is low, real-time performance of animation generation is poor, and a requirement for high real-time performance of animation generation cannot be met.

4. Real-time driving by motion capture: A real person (or referred to as an actor) wears a motion capture suit with a full-body sensor. The real person performs motions based on play script content and play script audio. The motion capture suit captures body motions and facial expressions performed by the real person, and reports the body motions and the facial expressions to a computer to which the motion capture suit is connected. The computer transfers the body motions and the facial expressions of a human body to a 3D model of an avatar to obtain 3D motion data and 3D expression data of each body part of the avatar, to drive the avatar to perform body motions and facial expressions similar to those of the real person at consecutive moments.

In the foregoing manner of driving by motion capture, although a requirement for real-time performance can be met, a technical threshold for using a motion capture device is high, and the motion capture device is expensive and may be used in professional film and television production. It is quite difficult to use the motion capture device to serve common users. The foregoing manner cannot be popularized in general scenarios such as livestreaming and gaming, and efficiency of animation generation for an avatar is low.

Some embodiments provide an animation generation method for an avatar, to streamline the following animation generation process in a game engine such as UE4: Video data of a physical object is captured by a USB external camera. An electronic device performs 3D reconstruction on the physical object, and outputs reconstructed motion data and expression data. The motion data controls a body motion of an avatar, and the expression data controls a facial expression of the avatar. Based on both the motion data and the expression data, a 3D model of the avatar can be driven to perform skeletal movement and make an expression in real time, to control the avatar to simulate the physical object to perform an animation behavior, and implement high-quality animation rendering on the avatar.

In the foregoing animation generation process, a machine can quickly and precisely generate animation data of the avatar without manual intervention, so that efficiency of animation generation is high, and a high requirement for real-time performance can be met. An animation can be generated and produced in real time by using only a camera, without an expensive motion capture device. The foregoing animation generation process can be popularized in various general scenarios in which an avatar may perform an animation behavior, for example, livestreaming, video on demand (VOD), gaming, and digital human videos.

The USB external camera enables the avatar to be run on many display devices without built-in cameras, and a skeletal component of the avatar is characterized by high replaceability, real-time driving, and the like, and is not limited to limited digital human components in a component library of the native digital human system of UE4. The foregoing animation generation process can be extended to an animation driving scenario for a digital human with any body type, any face adjustment, and any appearance. In addition to the digital human, real-time and quick animation generation can also be implemented for other avatars in games, animations, and films and television in this manner.

A system architecture of some embodiments are described below.

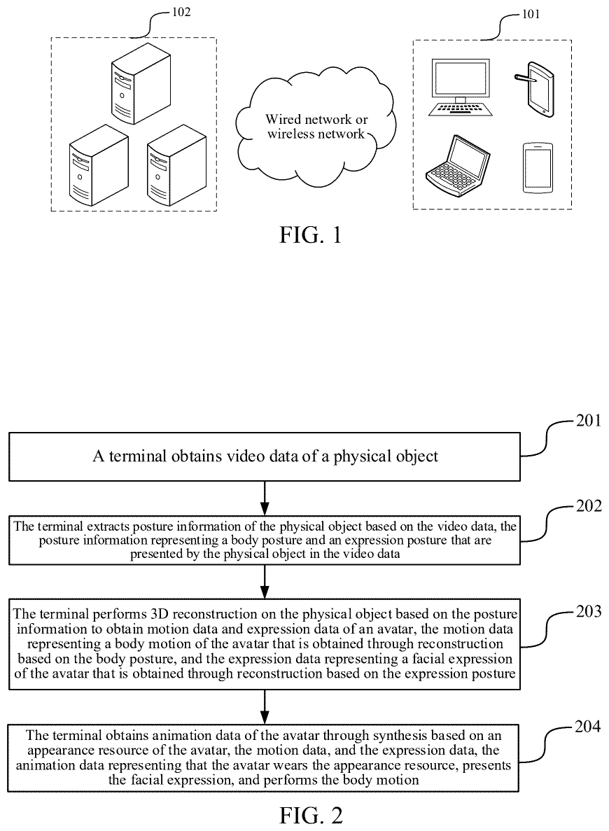

FIG. 1 is a schematic diagram of some embodiments of an animation generation method for an avatar according to some embodiments. As shown in FIG. 1, some embodiments may include a terminal 101 and a server 102. The terminal 101 and the server 102 are directly or indirectly connected through a wireless network or a wired network. The disclosure is not limited thereto.

An application supporting an avatar is installed on the terminal 101. The terminal 101 can implement animation generation for an avatar and other functions by using the application. The application can further have other functions, such as a game development function, a social networking function, a video sharing function, a video posting function, or a chat function. The application is a native application in an operating system (OS) of the terminal 101, or an application provided by a third party. For example, the application includes but is not limited to a game engine, an animation engine, a 3D animation application, a livestreaming application, a short video application, an audio/video application, a game application, a social application, or another application. In an example, the application is the UE4 engine or the Unity engine. This is not limited.

In some embodiments, the terminal 101 is a smartphone, a tablet computer, a notebook computer, a desktop computer, a smart speaker, a smart television, a smartwatch, an in-vehicle terminal, or the like, but is not limited thereto.

The server 102 provides a background service for the application supporting an avatar on the terminal 101. The server 102 may store 3D models of a plurality of avatars. A 3D model may be divided into a 3D skeletal model and a 3D facial model. A user can select a personalized appearance resource for an avatar in the application according to a requirement. The user can further perform face adjustment on the avatar: adjusting a facial feature configuration parameter (for example, an eye distance, a pupil distance, a mandible width, or a philtrum length) in the 3D facial model according to a requirement. The server 102 includes at least one of one server, a plurality of servers, a cloud computing platform, or a virtualization center. In some embodiments, the server 102 is responsible for primary computing work for animation generation, and the terminal 101 is responsible for secondary computing work for animation generation. The server 102 may be responsible for secondary computing work for animation generation, and the terminal 101 is responsible for primary computing work for animation generation. A distributed computing architecture may be used between the server 102 and the terminal 101 to perform collaborative computing for animation generation.

In some embodiments, the server 102 may be an independent physical server, a server cluster or a distributed system that includes a plurality of physical servers, or a cloud server that provides cloud computing services such as a cloud service, a cloud database, cloud computing, a cloud function, cloud storage, a network service, cloud communication, a middleware service, a domain name service, a security service, a content delinetwork (CDN), big data, and an AI platform.

The terminal 101 may be one of a plurality of terminals. In some embodiments, the terminal 101 is only used as an example for description. It is known to a person skilled in the art that there may be more or fewer terminals.

In some embodiments, during offline animation generation, a user connects a USB external camera to the terminal 101, and after a shooting permission is assigned to the external camera, the terminal 101 captures video data of the user (an exemplary physical object) through the USB external camera, and transmits an animation generation request carrying the video data to the server 102. In response to the animation generation request, the server 102 drives generation of animation data of an avatar based on the video data by using the animation generation method for an avatar in some embodiments, so that both a body motion and a facial expression of the avatar are highly similar to a body motion and a facial expression made by the user in the video data. Then the server 102 returns the animation data of the avatar to the terminal 101, so that the terminal 101 plays the animation data of the avatar. No expensive motion capture device may be connected to the terminal 101, and animation generation for the avatar is driven by a video signal, so that efficiency of animation generation is high.

In some embodiments, if an animation generation function is integrated into an application locally installed on the terminal 101, the terminal 101 may not request the server 102 to return animation data, and the terminal 101 may locally generate animation data of the avatar through driving by the video data, and then play the animation data of the avatar. Communication overheads of an animation generation process on the terminal 101 are reduced, and the server 102 may not be requested to participate in animation generation.

In some embodiments, during real-time animation generation, a user connects a USB external camera on the terminal 101, and after a shooting permission is assigned to the external camera, the terminal 101 captures a video data stream of the user (an exemplary physical object) through the USB external camera. The video data stream includes video frames captured at consecutive moments. The terminal 101 may push the video data stream to the server 102 in a streaming manner, to request the server 102 to drive real-time animation generation. The server 102 continuously receives the video data stream pushed by the terminal 101, and drives generation of an animation frame of an avatar based on each video frame in the video data stream by using the animation generation method for an avatar in some embodiments. A plurality of consecutive animation frames are generated through driving by a plurality of consecutive video frames, to obtain an animation data stream of the avatar through synthesis, so that a corresponding animation stream can be obtained through synthesis through driving by a video stream captured in real time, and a body motion and a facial expression of the avatar in the animation stream are controlled to be highly similar to a body motion and a facial expression made by the user in the video stream. Then the server 102 returns the animation data stream of the avatar to the terminal 101, so that the terminal 101 plays the animation data stream of the avatar. No expensive motion capture device may be connected to the terminal 101, and animation generation for the avatar is driven by a video stream signal. This manner has a quite low delay and can meet a high requirement for real-time performance. This manner has high efficiency of animation generation, and can be popularized in a scenario with a high requirement for real-time performance, for example, livestreaming or gaming.

In some embodiments, if an animation generation function is integrated into an application locally installed on the terminal 101, the terminal 101 may not request the server 102 to return an animation data stream, and the terminal 101 may locally generate an animation data stream of the avatar through driving by the video data stream, and then play the animation data stream of the avatar. Communication overheads of an animation generation process on the terminal 101 are reduced, and the server 102 may not be requested to participate in animation generation. This manner can be popularized in a scenario with a high requirement for real-time performance, for example, livestreaming or gaming.

The animation generation method for an avatar in some embodiments are applicable to any scenario in which an avatar animation may be generated. For example, in a digital human livestreaming scenario, a person behind may not be equipped with a motion capture suite for performance, but only a terminal with a camera may be used, where the terminal may not have a camera but a USB external camera is connected to the terminal. Provided that the terminal has a shooting function, after the person behind assigns a shooting permission, the terminal captures a video data stream (for example, a live video stream) of the person behind through a built-in camera or an external camera. Then the terminal locally generates, or requests the server to generate, an animation data stream of the digital human through synthesis under driving by the video data stream, to control the digital human to simulate a body motion and a facial expression of the person behind. Together with audio of the digital human and subtitles (or there may be no subtitle), this enhances realness and fun of digital human livestreaming. For another example, the method is further applicable to various scenarios in which an animation may be generated for an avatar, such as digital human customer service, animation production, film and television effects, digital human hosting, and digital human videos. An application scenario is not limited.

A basic process of the animation generation method for an avatar in some embodiments is described below.

FIG. 2 is a flowchart of an animation generation method for an avatar according to some embodiments. As shown in FIG. 2, some embodiments is performed by an electronic device. The electronic device may be a terminal or a server. Descriptions are made by using an example in which the electronic device is a terminal. Some embodiments may include the following operations:

201: The terminal obtains video data of a physical object.

The physical object is a movable object in a physical form in the real world, for example, a user (a real person), a robot, or an animal. A type of the physical object is not limited. For example, in a digital human livestreaming scenario, the physical object is a person behind who controls a virtual streamer. The person behind is a person who performs or controls a virtual streamer during livestreaming in a virtual livestreaming scenario.

The video data is video data or a video data stream that includes the physical object. The video data may include at least one video image, and the video data stream may include a plurality of video frames. Whether the video data is a video clip or a continuously captured video stream is not limited.

In some embodiments, the terminal has a built-in camera or an external camera. After requesting a shooting permission from the physical object, the terminal invokes the camera to capture the video data of the physical object when being fully authorized by the physical object. In an example, the external camera is a USB external camera, or an external camera that can be connected to the terminal through another interface.

In some embodiments, the terminal establishes a communication connection to an external image capture device. After being fully authorized by the physical object, the image capture device captures the video data of the physical object, and transmits the captured video data to the terminal through the communication connection, so that the terminal receives the video data. Whether the terminal performs shooting or the external image capture device performs shooting is not limited.

In some embodiments, the terminal reads the video data of the physical object from a local database, or the terminal downloads the video data of the physical object from a cloud database. A source of the video data is not limited.

202: The terminal extracts posture information of the physical object based on the video data, the posture information representing a body posture and an expression posture that are presented by the physical object in the video data.

The posture information represents the body posture and the expression posture presented by the physical object in the video data. The posture information is a 2D pose of the physical object in the video data.

In some embodiments, the posture information includes at least one of skeletal posture information or facial posture information. The skeletal posture information indicates a 2D pose of a skeletal key point of the physical object, and the facial posture information indicates a 2D pose of a facial key point of the physical object.

In an example, the 2D pose indicates position information and posture information. For any skeletal key point or facial key point, a U coordinate and a V coordinate in a planar coordinate system are configured for representing 2D position information in a 2D pose, and rotation angles in a U direction and a V direction are further configured for representing 2D posture information. The U coordinate is a horizontal coordinate of a 2D video image (or video frame) in the video data, and the V coordinate is a vertical coordinate of the 2D video image (or video frame) in the video data.

In some embodiments, when a body motion may be modeled, the posture information includes the skeletal posture information. The skeletal posture information of the physical object is extracted based on the video data obtained in operation 201. For example, 2D poses of a plurality of skeletal key points of the physical object are extracted, and the 2D poses of the plurality of skeletal key points are determined as the skeletal posture information. When a video data stream is obtained in operation 201, the skeletal posture information of the physical object is extracted from each video frame in the video data stream in the same manner.

In some embodiments, when a facial expression may be modeled, the posture information includes the facial posture information. The facial posture information of the physical object is extracted based on the video data obtained in operation 201. For example, 2D poses of a plurality of facial key points of the physical object are extracted, and the 2D poses of the plurality of facial key points are determined as the facial posture information. When a video data stream is obtained in operation 201, the facial posture information of the physical object is extracted from each video frame in the video data stream in the same manner.

In some embodiments, when a body motion and a facial expression may be modeled, the posture information includes the skeletal posture information and the facial posture information. The skeletal posture information and the facial posture information of the physical object are extracted based on the video data obtained in operation 201. For example, 2D poses of a plurality of skeletal key points of the physical object are extracted, and the 2D poses of the plurality of skeletal key points are determined as the skeletal posture information. 2d poses of a plurality of facial key points of the physical object are extracted, and the 2D poses of the plurality of facial key points are determined as the facial posture information. When a video data stream is obtained in operation 201, the skeletal posture information and the facial posture information of the physical object are extracted from each video frame in the video data stream in the same manner.

203: The terminal performs 3D reconstruction on the physical object based on the posture information to obtain motion data and expression data of an avatar, the motion data representing a body motion of the avatar that is obtained through reconstruction based on the body posture, and the expression data representing a facial expression of the avatar that is obtained through reconstruction based on the expression posture.

The motion data represents a 3D body posture of the avatar that is obtained by performing 3D reconstruction based on a 2D body posture of the physical object. The motion data is a 3D skeletal pose of the avatar that is obtained through simulation based on the physical object. The 3D skeletal pose includes 3D poses of a plurality of skeletal key points of the avatar.

The expression data represents a 3D expression posture of the avatar that is obtained by performing 3D reconstruction based on a 2D expression posture of the physical object. The expression data is a 3D facial pose of the avatar that is obtained through simulation based on the physical object. The 3D facial pose includes 3D poses of a plurality of facial key points of the avatar.

In an example, the 3D pose indicates position information and posture information. For any skeletal key point or facial key point, six pose parameters may be configured for representing a 3D pose of the skeletal key point or the facial key point. Three pose parameters represent position coordinates (for example, position information) in an X-Y-Z 3D spatial coordinate system, and the other three pose parameters represent rotation angles (for example, posture information) in the X-Y-Z 3D spatial coordinate system. In an example, the three rotation angles are collectively referred to as Euler angles, and the Euler angles include a pitch, a yaw, and a roll. The pitch represents an angle of rotation around an X-axis, the yaw represents an angle of rotation around a Y-axis, and the roll represents an angle of rotation around a Z-axis. For a facial key point, the pitch may be considered as an angle of “head nodding”, the yaw may be considered as an angle of “head shaking”, and the roll may be considered as an angle of “head tilting/swing”.

In some embodiments, when a body motion may be modeled, the posture information extracted in operation 202 includes the skeletal posture information. 3d skeletal reconstruction is performed on the physical object based on the skeletal posture information extracted in operation 202 to obtain the motion data of the avatar. For example, the skeletal posture information is provided as 2D poses of a plurality of skeletal key points. The motion data is provided as 3D poses of the plurality of skeletal key points. For each skeletal key point, the 3D skeletal reconstruction is a process of reconstructing a 3D pose of the skeletal key point based on a 2D pose of the skeletal key point. If facial expression reconstruction is ignored, the expression data of the avatar may be configured to be a preset expression (for example, no facial expression), or the expression data of the avatar is controlled by using an animator controller.

When a video data stream is obtained in operation 201, the skeletal posture information of the physical object is extracted from each video frame in operation 202, to implement per-frame 3D skeletal reconstruction to obtain motion data of the avatar in each animation frame.

In some embodiments, when a facial expression may be modeled, the posture information extracted in operation 202 includes the facial posture information. 3d facial reconstruction is performed on the physical object based on the facial posture information extracted in operation 202 to obtain the expression data of the avatar. For example, the facial posture information is provided as 2D poses of a plurality of facial key points. The expression data is provided as 3D poses of the plurality of facial key points. For each facial key point, the 3D facial reconstruction is a process of reconstructing a 3D pose of the facial key point based on a 2D pose of the facial key point. If skeletal reconstruction is ignored, the motion data of the avatar may be configured to be a preset motion (for example, a standing motion), or the motion data of the avatar is controlled by using an animator controller.

When a video data stream is obtained in operation 201, the facial posture information of the physical object is extracted from each video frame in operation 202, to implement per-frame 3D facial reconstruction to obtain expression data of the avatar in each animation frame.

In some embodiments, when a body motion and a facial expression may be modeled, the posture information extracted in operation 202 includes the skeletal posture information and the facial posture information. 3d skeletal reconstruction is performed on the physical object based on the skeletal posture information extracted in operation 202 to obtain the motion data of the avatar. For example, the skeletal posture information is provided as 2D poses of a plurality of skeletal key points. The motion data is provided as 3D poses of the plurality of skeletal key points. For each skeletal key point, the 3D skeletal reconstruction is a process of reconstructing a 3D pose of the skeletal key point based on a 2D pose of the skeletal key point. 3d facial reconstruction is performed on the physical object based on the facial posture information extracted in operation 202 to obtain the expression data of the avatar. For example, the facial posture information is provided as 2D poses of a plurality of facial key points. The expression data is provided as 3D poses of the plurality of facial key points. For each facial key point, the 3D facial reconstruction is a process of reconstructing a 3D pose of the facial key point based on a 2D pose of the facial key point.

In some embodiments, when a video data stream is obtained in operation 201, the skeletal posture information and the facial posture information of the physical object are extracted from each video frame in operation 202, to implement per-frame 3D skeletal reconstruction and 3D facial reconstruction to obtain motion data and expression data of the avatar in each animation frame.

204: The terminal obtains animation data of the avatar through synthesis based on an appearance resource of the avatar, the motion data, and the expression data, the animation data representing that the avatar wears the appearance resource, presents the facial expression, and performs the body motion.

The appearance resource is configured for controlling an external representation of the avatar. For example, the appearance resource includes but are not limited to hair, skin, eyes, clothing, ornaments, effects, and the like. The animation data may be rendered to visually display an image in which the avatar wears the appearance resource, presents the facial expression, and performs the body motion.

In some embodiments, the appearance resource of the avatar is queried based on an identification (ID) of the avatar, and the found appearance resource is synthesized with the motion data and the expression data that are reconstructed in operation 203, to obtain the animation data of the avatar, so that the avatar wears the appearance resource of the avatar and presents a body motion and a facial expression obtained by simulating the physical object.

When a video data stream is obtained in operation 201, the skeletal posture information and the facial posture information of the physical object are extracted from each video frame in operation 202, and the motion data and the expression data of the avatar are obtained through per-frame 3D reconstruction in operation 203. The animation data of the avatar can be obtained through per-frame synthesis in operation 204. An animation frame can be obtained through synthesis for each video frame in the video data stream, so that a body motion and a facial expression of the avatar in the animation frame are obtained by simulating a body motion and a facial expression of the physical object in the video frame.

In an example, during rendering of the animation data of the avatar, a 3D model of the avatar that is stored in a point cloud form can be queried based on the avatar ID of the avatar, the 3D model in the point cloud form may be baked to export mesh data of the 3D model, and then each skeletal component of the avatar is bound to a corresponding part in the mesh data to implement skeletal skinning of the 3D model. The 3D model includes a 3D skeletal model and a 3D facial model. The 3D skeletal model is split into a plurality of skeletal components, and the 3D facial model is considered as a skeletal component for controlling a facial expression motion. The body motion and the facial expression of the avatar can be controlled by using all skeletal components. The motion data in operation 203 controls each skeletal component included in the 3D skeletal model to present a body motion, and the expression data in operation 204 controls a skeletal component included in the 3D facial model to present a facial expression. After skeletal skinning is performed, when a skeletal component is displaced or rotated (a pose changes) due to impact of the motion data or the expression data, a vertex position of a vertex in the bound mesh data is naturally affected. A vertex position of each vertex in the mesh data may be recalculated. This is equivalent to applying deformation to a specified vertex in the mesh data by using the motion data and the expression data, to control a vertex of a skeletal skin to perform a position offset, so that a body motion and an expression posture presented by the avatar are controlled based on the vertex rather than being limited to some preset fixed animation behaviors. Reconstruction precision of the body motion and the facial expression is higher, and a restoration degree and vividness are higher.

A GPU rendering pipeline is driven, based on mesh data obtained by recalculating the vertex position and the appearance resource of the avatar, to perform a series of rendering processes such as vertex shading, rasterization, and pixel shading on the mesh data of the 3D model. Finally, the animation data of the avatar can be visually displayed, the animation data of the avatar is drawn on a display of the terminal, to display the animation data of the avatar. During real-time animation generation, provided that each animation frame of the avatar is displayed frame by frame, an animation of the avatar can be played, to implement real-time and dynamic animation driving.

In some embodiments, a render hardware interface (RHI) thread is created on the terminal. The appearance resource of the avatar and the mesh data obtained through deformation are submitted to the RHI thread. Then the RHI thread executes a DC command in a graphics API, to drive the GPU rendering pipeline to render the avatar to obtain an animation frame of the avatar.

A GPU rendering process for any animation frame is described below. The GPU rendering pipeline involves a VS, a rasterizer, and a PS. The VS is a rendering pipeline for performing calculation on a mesh vertex. The rasterizer is a rendering pipeline for assembling a result output by the VS into a triangular mesh and rasterizing the triangular mesh into discrete pixels based on a configuration. The PS is a rendering pipeline for performing shading calculation and pixel shading on each discrete pixel obtained through rasterization.

For each vertex in the mesh data, the motion data and the expression data control a vertex position. Posture information like a rotation angle may also affect a depth value of the vertex, and the appearance resource affects a color value and a depth value of the vertex. A color and a depth in a frame buffer are cleared. Then a depth of each vertex in the mesh data is written to a Z-buffer by using the VS. A depth value of each vertex is written to the Z-buffer. A depth sorting process is further involved herein. The depth sorting affects transparency and deals with some display effects such as occlusion or semi-transparency. Then rasterization is performed by using the rasterizer. Then a color of each discrete pixel is written to a color buffer by using the PS. A pixel value of each pixel is written to the color buffer. The pixel value of each pixel is obtained by integrating color values of vertices located at the pixel. Transparency of the vertices may be considered during the color value integration. Finally, an animation frame of the avatar can be output on the display of the terminal. Illumination calculation is involved in the vertex shading stage. An illumination model is determined based on the avatar or a rendering engine.

The frame buffer is configured to store data of all pixels in a current animation frame. The frame buffer includes a Z-buffer and a color buffer. The Z-buffer is a depth buffer in the frame buffer, and is configured to store a depth value of each pixel in the current animation frame. The color buffer is configured to store a color value of each pixel in the current animation frame.

All of the foregoing technical solutions can be combined in any manner to form some embodiments. Details are not described herein.

According to the method provided in some embodiments, a body posture and an expression posture presented by a physical object in a planar coordinate system are extracted based on video data of the physical object. Then 3D reconstruction is performed on the physical object to obtain a body motion and a facial expression presented by an avatar in a spatial coordinate system. Then animation data of the avatar is obtained through synthesis based on an appearance resource of the avatar. The avatar can simulate the body motion and the facial expression of the physical object under driving by the video data. This animation generation process can be popularized in general scenarios such as livestreaming and gaming without relying on an expensive motion capture device. An animation can be reconstructed in real time, to meet a high requirement for real-time performance, and achieve a low delay of animation generation and high efficiency of animation generation.

Because animation rendering does not rely on a skeletal animation or a native digital human system of UE4, a synthetic avatar animation is not limited to several preset motion types, and stiffness and unsmoothness can be avoided during animation presentation. Animation control on the avatar can be implemented vertex by vertex. Reconstruction precision of a body motion and a facial expression of the avatar is accurate to a vertex in the mesh data of the avatar. The avatar can be controlled to precisely simulate a body motion and a facial expression of the physical object at high precision, to improve precision of animation generation for the avatar, achieve high flexibility and controllability, and optimize animation effects of the avatar.

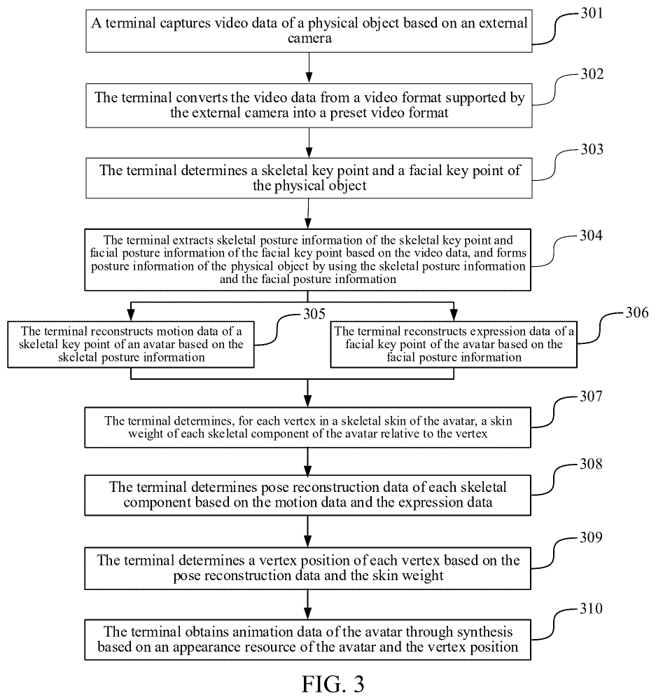

FIG. 3 is a flowchart of an animation generation method for an avatar according to some embodiments. Some embodiments is performed by an electronic device. The electronic device may be a terminal or a server. Descriptions are made by using an example in which the electronic device is a terminal. Some embodiments may include the following operations:

301: A terminal captures video data of a physical object based on an external camera.

In some embodiments, when the terminal is equipped with the external camera, after requesting a shooting permission from the physical object and being fully authorized by the physical object, the terminal captures the video data of the physical object through the external camera. In an example, the external camera is a USB external camera, or an external camera that can be connected to the terminal through another interface.

In operation 301, only an example in which the video data is captured through the external camera is used for description. In some embodiments, if the terminal is equipped with a built-in camera, the terminal may capture the video data through the built-in camera. A camera type is not limited.

In some embodiments, in addition to capturing the video data through the built-in camera or the external camera, the terminal may establish a communication connection to an external image capture device. After being fully authorized by the physical object, the image capture device captures the video data of the physical object, and transmits the captured video data to the terminal through the communication connection, so that the terminal receives the video data. Whether the terminal performs shooting or the external image capture device performs shooting is not limited.

In some embodiments, in addition to capturing the video data, the terminal may read the video data of the physical object from a local database, or the terminal may download the video data of the physical object from a cloud database. A source of the video data is not limited.

The video data captured in operation 301 is video data or a video data stream that includes the physical object. The video data may include at least one video image, and the video data stream may include a plurality of video frames. Whether the video data is a video clip or a continuously captured video stream is not limited.

For example, in a scenario of capturing a video data stream, the external camera is a USB external camera. A hardware requirement for the terminal is low, and the terminal can implement the animation generation solution of this application provided that the terminal has a USB port. After the USB external camera is inserted into (physically connected to) the USB port of the terminal, access configuration (driver adaptation) is performed for the USB external camera to establish a communication connection between the USB external camera and the terminal. After requesting a shooting permission from the physical object, the terminal can invoke a camera application programming interface (API) through an OS, to drive, through the camera API, the USB external camera to capture a video data stream of the physical object in real time, and transmit the captured video data stream to the terminal in a streaming manner. Provided that invocation logic applicable to different OSs is packaged into the USB external camera, video data can be captured in real time on a terminal based on any platform. A user is unaware of an underlying invocation. Provided that a shooting permission is assigned, the camera API can be invoked to drive the USB external camera to complete shooting, and obtain a video data stream returned by the USB external camera.

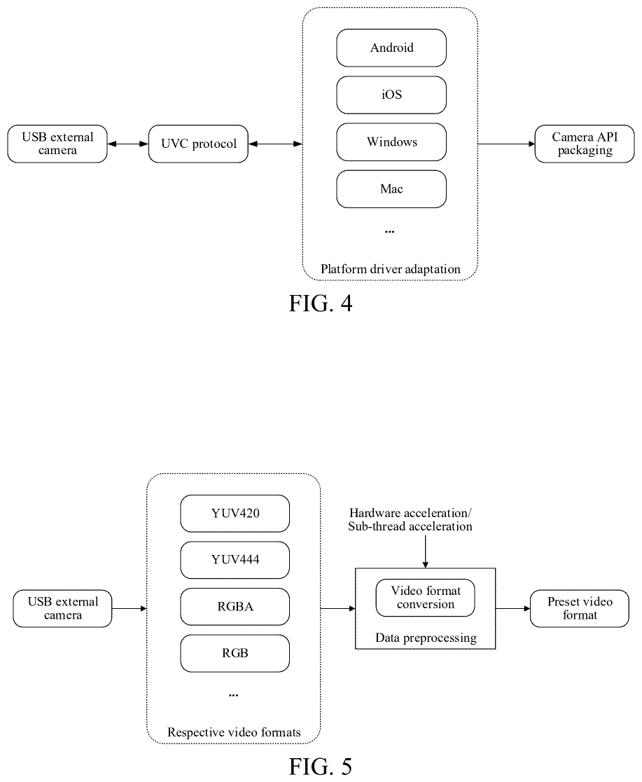

FIG. 4 is a flowchart of a principle of an animation generation solution for an avatar according to some embodiments. As shown in FIG. 4, for the USB external camera, to ensure that the USB external camera can be connected to the terminal, both the USB external camera and the terminal may support the UVC protocol. The terminal can recognize the connection of the USB external camera, and the terminal and the USB external camera can adapt to drivers of different platforms through the UVC protocol. After the physical connection and the driver adaptation are completed, the terminal can invoke the camera API to drive the USB external camera to capture a video data stream, and the USB external camera can return the captured video data stream to the terminal. A platform (for example, an OS) to which the terminal belongs includes but is not limited to Android, iOS, Windows, Mac, and the like. A device type, a platform type, and an OS type of the terminal are not limited.

In some embodiments, the USB external camera is packaged into a unified camera API at different platform layers. When invoking the camera API, the OS of the terminal can implement the invocation without awareness, may not care about a type of a camera API that may be invoked at the platform to drive the USB external camera. This can improve video data capture efficiency. The USB external camera may be packaged into different camera APIs at different platform layers. When driving the USB external camera, the OS may select and invoke a camera API based on a platform to which the terminal belongs. This is not limited.

In some embodiments, before driving the USB external camera to capture a video data stream, the user may further configure shooting performance of the USB external camera by using the terminal, for example, configure a capture resolution of the USB external camera, whether to use a long-focus lens/short-focus lens for capture, or whether to enable an image stabilization function of the camera. The shooting performance of the USB external camera can be flexibly configured, to help capture a video data stream with higher quality.

302: The terminal converts the video data from a video format supported by the external camera into a preset video format.

The preset video format is a format supporting 3D reconstruction of the physical object.

In some embodiments, video data captured by different external cameras may be in different video formats. To improve efficiency of 3D reconstruction, the video data captured by the external camera may be uniformly converted from an original video format into the preset video format, to facilitate subsequent 3D reconstruction based on video data in the preset video format. Operation 302 may also be referred to as a data preprocessing process. Operation 302 is not a mandatory operation. If the video format supported by the external camera is a format supporting 3D reconstruction of the physical object, no computing power may be consumed to convert the video format. This is not limited. The video format is a data format (for example, a picture format or an image format) of a video frame or a video image.

In the foregoing operations 301 and 302, some embodiments of obtaining the video data of the physical object by the terminal is provided. The external camera is invoked to capture the video data, and the video data is uniformly converted into the preset video format. Some embodiments is applicable to a scenario of capturing a video stream in real time to drive a real-time animation stream, and can meet a service requirement for high real-time performance. Some embodiments is also applicable to a scenario of recording a video offline to drive an animation. The preset video format can be well compatible with a 3D reconstruction algorithm, to improve efficiency of 3D reconstruction. No expensive motion capture device may be configured, and costs are low, so that some embodiments is for popularization and has quite high universality and applicability.

In an example, FIG. 5 is a diagram of a principle of video format conversion according to some embodiments. As shown in FIG. 5, if the external camera is a USB external camera, because the USB external camera uses a variety of video coding schemes, captured video data is also in a variety of video formats. In a data preprocessing stage, the video data in a variety of video formats is uniformly converted into video data in a preset video format. The preset video format is a data format supported by a 3D reconstruction algorithm. In some embodiments, hardware acceleration may be enabled during video format conversion, to reduce a delay of video format conversion and improve real-time performance of animation generation. The hardware acceleration is not a mandatory operation.

In some embodiments, video formats include but are not limited to YUV420, YUV444, RGBA, RGB, and the like. YUV is a color coding scheme that decomposes a pixel value into components of three channels: Y (luminance), U (chrominance), and V (chroma). The YUV420 and the YUV444 both use the YUV color coding scheme but have different sampling modes. The YUV444 indicates 4:4:4 sampling. Each Y corresponds to a group of UV components. The YUV420 indicates 4:2:0 sampling. Efour Ys share a group of UV components. The RGB is another color coding scheme that decomposes a pixel value into components of three channels: R (red), G (green), and B (blue). The RGBA indicates that a transparency channel, for example, alpha, is additionally added based on the RGB channels.

In an example, assuming that the preset video format is the RGB or the RGBA, if the video data captured by the USB external camera is in the YUV420 or YUV444 format, the video data may be converted from the YUV420 or YUV444 format into the RGB or RGBA format. This is equivalent to a mapping from the YUV color coding scheme to the RGB color coding scheme, conversion from a non-RGB color format to an RGB color format.

In an example, assuming that the preset video format is the YUV420 or the YUV444, if the video data captured by the USB external camera is in the RGB or RGBA format, the video data may be converted from the RGB or RGBA format into the YUV420 or YUV444 format. This is equivalent to a mapping from the RGB color coding scheme to the YUV color coding scheme, conversion from an RGB color format to a non-RGB color format.

In some embodiments, conversion from the YUV color coding scheme to the RGB color coding scheme is used as an example. During video format conversion, video data may be accessed through a CPU logic layer, and pixel values are read pixel by pixel. Then a pixel value in a source coding format is input to a conversion logic function, and a pixel value in a target coding format is output. In this example, the source coding format is the YUV color coding scheme, the target coding format is the RGB color coding scheme, and the conversion logic function is a function for converting a pixel value from the YUV color coding scheme to the RGB color coding scheme.

Because the terminal creates a main thread (for example, an animation thread or a rendering thread) for animation generation, in the video format conversion method in the foregoing example, a current main thread for animation generation on the terminal is blocked, and subsequent logic of the main thread is not executed until all pixels are converted by using a color coding scheme. The video format conversion process may cause a delay of animation generation.

In some embodiments, video format conversion may be accelerated, to reduce a delay of the process and ensure that animation generation can meet a high requirement for real-time performance. The acceleration operation is not a mandatory operation in the data preprocessing stage, and the video format conversion may not be accelerated. Two possible manners of accelerating video format conversion are described below.

### Manner 1: Parallel Acceleration by Using a Sub-Thread

In some embodiments, a sub-thread configured for format conversion may be started, and the video data is converted from the video format supported by the external camera into the preset video format by using the sub-thread. During animation generation, to avoid blocking of the main thread due to video format conversion, a sub-thread startup instruction may be executed to start a sub-thread when video format conversion is started. The sub-thread runs independently to complete video format conversion, and the main thread continues to run subsequent logic without being blocked. After completing video format conversion for all pixels, the sub-thread notifies the main thread that the video format conversion is completed. This is equivalent to providing an acceleration manner in which the main thread and the sub-thread performs parallel processing. This can reduce a delay of animation generation and improve real-time performance of animation generation. In some embodiments, the sub-thread startup instruction may be a NEON instruction.

In some embodiments, similar to parallel acceleration by using a sub-thread, a coroutine configured for format conversion may be started, and the video data is converted into the preset video format by using the coroutine.

### Manner 2: GPU Hardware Acceleration

In some embodiments, a DC command of a GPU may be invoked, and the video data is converted from the video format supported by the external camera into the preset video format by using the GPU. In an example, captured video data can be input from a CPU to the GPU by invoking a DC command provided by a graphics API supported by the GPU, then video format conversion can be completed for each pixel in the GPU by using shader code of a GPU rendering pipeline, and finally, the CPU may read a texture of the GPU. Video data that is in the preset video format and that is obtained through conversion can be returned to the CPU. During animation generation, video format conversion is performed by the GPU, to implement GPU hardware acceleration. The video format conversion is migrated from the CPU to the GPU. Hardware of the GPU is for massive parallel calculation, and a calculation speed is higher than that of the CPU by several orders of magnitude. Hardware acceleration can greatly improve efficiency of video format conversion, reduce a delay of animation generation, and improve real-time performance of animation generation.

303: The terminal determines a skeletal key point and a facial key point of the physical object.

In some embodiments, during 3D reconstruction of the physical object, 3D reconstruction of a human body may be performed by using a human body parameter model. A shape of the human body can be described by using only a group of low-dimensional vectors. Provided that 2D poses of the skeletal key point and the facial key point are extracted, a body posture and an expression posture of the physical object in a 2D planar coordinate system can be described. This key point-based 3D reconstruction manner has low calculation complexity and high 3D reconstruction efficiency. In some embodiments, the human body parameter model may be the skinned multi-person linear (SMPL) model, the SMPL-X model, the SCAPE model, or the like. The human body parameter model is not limited.

In the foregoing parameterized 3D reconstruction process, when different human body parameter models are used, a division manner for the skeletal key point and the facial key point may vary. A plurality of skeletal key points and a plurality of facial key points may be determined based on the human body parameter model used in 3D reconstruction.

304: The terminal extracts skeletal posture information of the skeletal key point and facial posture information of the facial key point based on the video data, and forms posture information of the physical object by using the skeletal posture information and the facial posture information.

The skeletal posture information represents a 2D pose of the skeletal key point, and the facial posture information represents a 2D pose of the facial key point.

In an example, the 2D pose indicates position information and posture information. For any skeletal key point or facial key point, a U coordinate and a V coordinate in a planar coordinate system are configured for representing 2D position information in a 2D pose, and rotation angles in a U direction and a V direction are further configured for representing 2D posture information. The U coordinate is a horizontal coordinate of a 2D video image (or video frame) in the video data, and the V coordinate is a vertical coordinate of the 2D video image (or video frame) in the video data.

In some embodiments, because the video data includes a 2D pose of a key point in the 2D planar coordinate system, for each skeletal key point, a 2D pose of the skeletal key point in the 2D planar coordinate system may be extracted based on the video data, and 2D poses of all skeletal key points in operation 303 are used as skeletal posture information of the physical object. For each facial key point, a 2D pose of the facial key point in the 2D planar coordinate system may be extracted, and 2D poses of all facial key points in operation 303 are used as facial posture information of the physical object. When a video data stream is obtained in operation 301, the skeletal posture information and the facial posture information of the physical object are extracted from each video frame in the video data stream in the same manner.

In some embodiments, for example, parameterized 3D reconstruction of the human body is performed by using the SMPL model. In operation 303, a plurality of skeletal key points and a plurality of facial key points in the SMPL model are determined. In operation 304, for each skeletal key point, a 2D pose of the skeletal key point can be extracted from the video data (or a video frame), and 2D poses of all the skeletal key points in the SMPL model are used as skeletal posture information of the physical object. For each facial key point, a 2D pose of the facial key point can be extracted from the video data (or a video frame), and 2D poses of all the facial key points in the SMPL model are used as facial posture information of the physical object.

In the foregoing operations 303 and 304, some embodiments of extracting the posture information of the physical object based on the video data is provided. The posture information represents the body posture and the expression posture presented by the physical object in the video data. The posture information is a 2D pose of the physical object in the video data. Descriptions are provided herein by using an example in which the posture information is decomposed into the skeletal posture information and the facial posture information.

In some embodiments, if animation generation focuses on a facial expression (for example, the USB external camera focuses only on a head and a neck), a body motion may not be modeled, and no skeletal posture information may be extracted. If animation generation focuses on a body motion (for example, some body performance is performed), a facial expression may not be modeled, and no facial posture information may be extracted. This is not limited.

In still some embodiments, in the foregoing operations 303 to 304, some embodiments of implementing 3D reconstruction of the human body based on a parameterized method is provided. Only a small quantity of parameters may be extracted to describe a highly complex human body mesh. For example, in the SMPL, only a minimum of 72+10 parameters are for describing a human body mesh with 6890 vertices. This method is characterized by high 3D reconstruction efficiency. In addition to the parameterized method, 3D reconstruction of the human body may be performed in some non-parameterized manners. A high-dimensional human body mesh is directly reconstructed. A 3D reconstruction method is not limited.

The posture information includes the skeletal posture information and the facial posture information.

305: The terminal reconstructs motion data of a skeletal key point of the avatar based on the skeletal posture information.

The motion data includes a 3D pose of the skeletal key point. The motion data represents a 3D body posture of the avatar that is obtained by performing 3D reconstruction based on a 2D body posture of the physical object. The motion data is a 3D skeletal pose of the avatar that is obtained through simulation based on the physical object.

In an example, the 3D pose indicates position information and posture information. For any skeletal key point, six pose parameters may be configured for representing a 3D pose of the skeletal key point. Three pose parameters represent position coordinates (for example, position information) in an X-Y-Z 3D spatial coordinate system, and the other three pose parameters represent rotation angles (for example, posture information) in the X-Y-Z 3D spatial coordinate system. In an example, the three rotation angles are collectively referred to as Euler angles, and the Euler angles include a pitch, a yaw, and a roll. The pitch represents an angle of rotation around an X-axis, the yaw represents an angle of rotation around a Y-axis, and the roll represents an angle of rotation around a Z-axis.

In some embodiments, the terminal performs 3D skeletal reconstruction on the physical object based on the skeletal posture information extracted in operation 304, to obtain the motion data of the avatar. The skeletal posture information is provided as 2D poses of a plurality of skeletal key points, and the motion data is provided as 3D poses of the plurality of skeletal key points. For each skeletal key point, the 3D skeletal reconstruction is a process of reconstructing a 3D pose of the skeletal key point based on a 2D pose of the skeletal key point.

In some embodiments, a pose mapping relationship from the 2D planar coordinate system to the 3D spatial coordinate system is established. For each skeletal key point, a 2D pose of the skeletal key point is mapped based on the pose mapping relationship, to obtain a 3D pose of the skeletal key point. Then 3D poses of all skeletal key points in operation 303 are used as motion data of the avatar. In some embodiments, the pose mapping relationship is established by using a 3D reconstruction algorithm. The 3D reconstruction algorithm may be implemented by using a computer program or a machine learning model. The 3D reconstruction algorithm may be integrated into a game engine such as UE4 in a form of a plug-in. This is not limited.

When a video data stream is obtained in operation 301, the skeletal posture information of the physical object is extracted from each video frame in operation 304, to implement per-frame 3D skeletal reconstruction in operation 305 to obtain motion data of the avatar in each animation frame.

306: The terminal reconstructs expression data of a facial key point of the avatar based on the facial posture information.

The expression data includes a 3D pose of the facial key point. The expression data represents a 3D expression posture of the avatar that is obtained by performing 3D reconstruction based on a 2D expression posture of the physical object. The expression data is a 3D facial pose of the avatar that is obtained through simulation based on the physical object.

In an example, the 3D pose indicates position information and posture information. For any facial key point, six pose parameters may be configured for representing a 3D pose of the facial key point. Three pose parameters represent position coordinates (for example, position information) in an X-Y-Z 3D spatial coordinate system, and the other three pose parameters represent rotation angles (for example, posture information) in the X-Y-Z 3D spatial coordinate system. In an example, the three rotation angles are collectively referred to as Euler angles, and the Euler angles include a pitch, a yaw, and a roll. The pitch represents an angle of rotation around an X-axis, the yaw represents an angle of rotation around a Y-axis, and the roll represents an angle of rotation around a Z-axis. For a facial key point, the pitch may be considered as an angle of “head nodding”, the yaw may be considered as an angle of “head shaking”, and the roll may be considered as an angle of “head tilting/swing”.

In some embodiments, the terminal performs 3D facial reconstruction on the physical object based on the facial posture information extracted in operation 304, to obtain expression data of the avatar. The facial posture information is provided as 2D poses of a plurality of facial key points, and the expression data is provided as 3D poses of the plurality of facial key points. For each facial key point, the 3D facial reconstruction is a process of reconstructing a 3D pose of the facial key point based on a 2D pose of the facial key point.

In some embodiments, a pose mapping relationship from the 2D planar coordinate system to the 3D spatial coordinate system is established. For each facial key point, a 2D pose of the facial key point is mapped based on the pose mapping relationship, to obtain a 3D pose of the facial key point. Then 3D poses of all facial key points in operation 303 are used as expression data of the avatar. In some embodiments, the pose mapping relationship is established by using a 3D reconstruction algorithm. The 3D reconstruction algorithm may be implemented by using a computer program or a machine learning model. The 3D reconstruction algorithm may be integrated into a game engine such as UE4 in a form of a plug-in. This is not limited.

When a video data stream is obtained in operation 301, the facial posture information of the physical object is extracted from each video frame in operation 304, to implement per-frame 3D facial reconstruction in operation 306 to obtain expression data of the avatar in each animation frame.

In the foregoing operations 305 and 306, some embodiments of performing 3D reconstruction on the physical object based on the posture information of the physical object to obtain the motion data and the expression data of the avatar is provided. The motion data represents a body motion of the avatar that is obtained through reconstruction based on the body posture, and the expression data represents a facial expression of the avatar that is obtained through reconstruction based on the expression posture. Because the posture information is decomposed into the skeletal posture information and the facial posture information, the motion data may be reconstructed based on the skeletal posture information, and the expression data may be reconstructed based on the facial posture information. Precise 3D reconstruction is separately performed on the motion data and the expression data, so that precision and rendering effects of animation generation may be improved.

In some embodiments, if animation generation focuses on a facial expression (for example, the USB external camera focuses only on a head and a neck), a body motion may not be modeled. No skeletal posture information may be extracted, no 3D skeletal reconstruction may be performed, and it is only to configure the motion data of the avatar to be a standing motion, or configure a change of an animation node of the avatar based on an animator controller. If animation generation focuses on a body motion (for example, some body performance is performed), a facial expression may not be modeled. No facial posture information may be extracted, no 3D facial reconstruction may be performed, and it is only to configure the expression data of the avatar to be no facial expression, or drive a change in a lip shape based on audio content. This is not limited.

307: The terminal determines, for each vertex in a skeletal skin of the avatar, a skin weight of each skeletal component of the avatar relative to the vertex.

In an example, the skin weight represents a degree of impact of the skeletal component on the vertex.

In some embodiments, the terminal first obtains mesh data of the avatar, and then binds the mesh data to each skeletal component to obtain the skeletal skin of the avatar. The skeletal skin includes a plurality of vertices. For each vertex, a skin weight of each skeletal component relative to the vertex is determined.

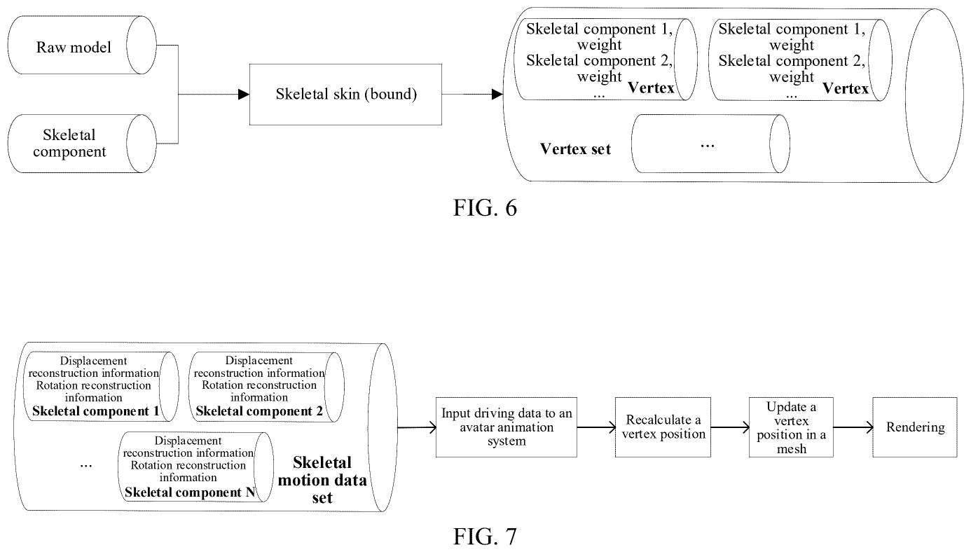

In some embodiments, FIG. 6 is a diagram of a principle of a skeletal skinning manner according to some embodiments. A raw model (for example, a 3D model) and skeletal components of the avatar are obtained, and the raw model is bound to the skeletal components to obtain the skeletal skin of the avatar. The skeletal skin herein is an avatar mesh to which the skeletal components are bound. The skeletal skin may actually be represented as a mesh vertex set. For each vertex in the mesh vertex set, a skin weight of each skeletal component relative to the vertex may be calculated. For example, when N (N>2) skeletal components are included, for a vertex v, a skin weight of a skeletal component 1 relative to the vertex v is calculated, a skin weight of a skeletal component 2 relative to the vertex v is calculated, and so on, until a skin weight of a skeletal component N relative to the vertex v is calculated. N skin weights are obtained for the vertex v, and each skin weight indicates a degree of impact of a corresponding skeletal component on the vertex v. The N skin weights can indicate skeletal components that affect the vertex v, and weights of impact.

A possible skeletal skin obtaining manner is described below in operations A1 and A2.

A1: The terminal exports the mesh data of the avatar based on the 3D model of the avatar.

In an example, the 3D model performs a default body motion and has a default facial expression. For example, the default body motion is a body motion without a meaning, for example, a static standing motion with four limbs naturally placed. For example, the default facial expression is a facial expression without an emotion, for example, a static face with no expression and with five facial features in natural conditions. The mesh data represents a meshed outer surface of the 3D model.

In some embodiments, the terminal stores respective 3D models of a plurality of different types of avatars in a point cloud form. A 3D model of the avatar that is stored in the point cloud form can be queried based on an avatar ID of the avatar, and the 3D model in the point cloud form may be baked to export mesh data (for example, an original mesh) of the 3D model.

In some embodiments, if the avatar supports a personalized face adjustment operation of a user, if the user can edit a facial feature configuration parameter (for example, an eye distance, a pupil distance, a mandible width, or a philtrum length) of the avatar by using the face adjustment operation, the terminal may further store a face adjustment parameter of the user, and first adjust a point cloud position in the 3D model of the avatar based on the face adjustment parameter, and then export mesh data based on an adjusted 3D model, to ensure that the exported mesh data conforms to the face adjustment parameter customized by the user.

A2: The terminal binds, to each skeletal component of the 3D model, mesh data of a part associated with the skeletal component, to obtain the skeletal skin of the avatar.

In an example, the skeletal component represents a skeleton of the part.

In some embodiments, the 3D model includes a 3D skeletal model and a 3D facial model. The 3D skeletal model is split into a plurality of skeletal components, and the 3D facial model is considered as a skeletal component for controlling a facial expression motion. The body motion and the facial expression of the avatar can be controlled by using all skeletal components. The terminal may bind each skeletal component of the avatar to a corresponding part in the mesh data to implement skeletal skinning of the 3D model.

In the foregoing operations A1 and A2, because different avatars may have different body shapes, skeletal skins of different avatars can be exported by only replacing a skeletal component, to adapt to different types of avatars with high universality. In some embodiments, the terminal may prestore a skeletal skin of each avatar. The terminal may query the skeletal skin of the avatar based on an avatar ID of the avatar. Assuming that the avatar is configured with N skeletal components, N skin weights of each vertex in the skeletal skin are exported after the skeletal skin of the avatar is obtained.

308: The terminal determines pose reconstruction data of each skeletal component based on the motion data and the expression data.

In some embodiments, each skeletal component included in the 3D skeletal model can be controlled, based on the motion data in operation 305, to present a body motion. A skeletal component included in the 3D facial model can be controlled, based on the expression data in operation 306, to present a facial expression. The body motion and the facial expression of the avatar can be synthesized to obtain animation data of the avatar.

In some embodiments, for ease of synthesis of the animation data, a skeletal component is considered as a unit. For each skeletal component, pose reconstruction data of the skeletal component is determined. Deformation (for example, an offset) can be applied to each vertex in the skeletal skin based on a skin weight.

In the following operations B1 to B4, some embodiments of obtaining pose reconstruction data is provided. Pose reconstruction data is obtained per skeletal component. A skeletal animation can be directly implemented by using the pose reconstruction data of the skeletal component, to improve efficiency of animation generation. A per-vertex animation with vertex-level precision may be further obtained through synthesis, to improve fineness of animation generation and improve flexibility of animation generation.

B1: The terminal determines a reconstructed key point included in each skeletal component of the avatar.

In some embodiments, for each of N (N>2) skeletal components of the avatar, a plurality of reconstructed key points included in the skeletal component may be determined from the 3D model of the avatar. The reconstructed key points include at least one of a skeletal key point or a facial key point. This is not limited.

B2: When the reconstructed key point includes a skeletal key point, the terminal determines a 3D pose of the reconstructed key point based on the motion data.

In some embodiments, if the plurality of reconstructed key points in operation B1 include at least one skeletal key point, based on the motion data in operation 305, because the motion data includes a 3D pose of each skeletal key point, a 3D pose of the at least one skeletal key point can be obtained by querying the motion data, to find a 3D pose of each skeletal key point included in the reconstructed key points. If the plurality of reconstructed key points in operation B1 do not include any skeletal key point, operation B2 may not be performed.

B3: When the reconstructed key point includes a facial key point, the terminal determines a 3D pose of the reconstructed key point based on the expression data.

In some embodiments, if the plurality of reconstructed key points in operation B1 include at least one facial key point, based on the expression data in operation 306, because the expression data includes a 3D pose of each facial key point, a 3D pose of the at least one facial key point can be obtained by querying the expression data, to find a 3D pose of each facial key point included in the reconstructed key points. If the plurality of reconstructed key points in operation B1 do not include any facial key point, operation B3 may not be performed.

B4: The terminal determines 3D poses of all reconstructed key points included in the skeletal component as the pose reconstruction data of the skeletal component.

In some embodiments, 3D poses of all reconstructed key points that are obtained in operations B2 and B3 are determined as pose reconstruction data of a current skeletal component. A 3D pose of each reconstructed key point includes two dimensions: position information and rotation information. For example, six pose parameters are configured for representing the 3D pose of each reconstructed key point. Three pose parameters represent position coordinates (for example, the position information) in an X-Y-Z 3D spatial coordinate system, and the other three pose parameters represent rotation angles (for example, the rotation information) in the X-Y-Z 3D spatial coordinate system. The pose reconstruction data of each skeletal component may be considered as including displacement reconstruction information and rotation reconstruction information.

In operations B1 to B4, some embodiments of obtaining pose reconstruction data is provided. Regardless of whether a skeletal component includes a facial key point or a skeletal key point, pose reconstruction data of the skeletal component can be obtained. This ensures accuracy of the pose reconstruction data. After the pose reconstruction data of each skeletal component is obtained, a skeletal animation may be directly implemented by using the pose reconstruction data of the skeletal component, to improve efficiency of animation generation. Operation 309 may be performed to further obtain a per-vertex animation with vertex-level precision through synthesis, to improve fineness of animation generation and improve flexibility of animation generation.

309: The terminal determines a vertex position of each vertex based on the pose reconstruction data and the skin weight.

In some embodiments, after skeletal skinning is performed, when a skeletal component is displaced or rotated (a pose changes) due to impact of the motion data or the expression data, a vertex position of a vertex in the bound mesh data is naturally affected. A vertex position of each vertex in the mesh data may be recalculated. This is equivalent to applying deformation to a specified vertex in the mesh data by using the motion data and the expression data, to control a vertex of a skeletal skin to perform a position offset, so that a body motion and an expression posture presented by the avatar are controlled based on the vertex rather than being limited to some preset fixed animation behaviors. Reconstruction precision of the body motion and the facial expression is higher, and a restoration degree and vividness are higher.

In the following operations C1 and C2, a manner of determining a vertex position of a single vertex is described by using a position change process for a single vertex in the skeletal skin as an example.

C1: For each vertex of the skeletal skin, the terminal determines an associated skeletal component of the vertex from skeletal components based on skin weights of the skeletal components relative to the vertex.

In some embodiments, for each vertex in the skeletal skin obtained in operation 307, N (N>2) skin weights of N skeletal components relative to the vertex are calculated. At least one associated skeletal component of the vertex can be found from the N skeletal components based on the N skin weights of the vertex.

In some embodiments, an impact threshold may be preconfigured. If a skin weight of any skeletal component is greater than the impact threshold, the skeletal component is determined as an associated skeletal component of the vertex. The impact threshold is a preconfigured value or a default value. For example, the impact threshold is 0, or a value greater than or equal to 0, for example, 0.2 or 0.5. A value of the impact threshold is not limited herein. If skin weights of all skeletal components are less than or equal to the impact threshold, no vertex position may be recalculated for the vertex, position calculation is skipped for the current vertex, and vertex position calculation is started for a next vertex.

In some embodiments, the N skeletal components may be sorted in descending order of skin weights, and the top K skeletal components obtained through sorting are selected as K associated skeletal components of the vertex, where K>1. This is equivalent to that no impact threshold may be configured, and the top K associated skeletal components are preferentially selected for recalculating a vertex position. A manner of selecting an associated skeletal component is not limited.

C2: The terminal determines a vertex position of the vertex based on pose reconstruction data of the associated skeletal component and the skin weight.

In some embodiments, for each vertex in the skeletal skin, K (K>1) associated skeletal components can be selected from the N skeletal components in operation C1. The vertex position of the vertex can be recalculated by using only K pieces of pose reconstruction data, obtained in operation 308, of the K associated skeletal components, and K skin weights of the K associated skeletal components relative to the vertex. In some embodiments, weighted summation is performed on the K pieces of pose reconstruction data by using the K skin weights respectively, to obtain an offset vector of the vertex, and the offset vector is applied to an initial position of the vertex in the skeletal skin to obtain an updated vertex position of the vertex.

In an example, FIG. 7 is a diagram of a principle of an animation driving process according to some embodiments. The pose reconstruction data of the N skeletal components obtained in operation 308 is considered as a skeletal motion data set. The skeletal motion data set includes the pose reconstruction data of the N skeletal components, and each piece of pose reconstruction data includes one piece of displacement reconstruction information and one piece of rotation reconstruction information. The skeletal motion data set is referred to as driving data. After the driving data is input to an avatar animation system, the avatar animation system may recalculate a vertex position of each vertex in the skeletal skin, update the vertex position of each vertex in the skeletal skin, and then input the vertex position to operation 310 for rendering. This is equivalent to determining, through calculation, whether each vertex may be deformed (or offset) under impact of the driving data, and a vertex position obtained after deformation. An animation behavior of the avatar can be controlled at a vertex granularity.

In operations C1 and C2, for each vertex, only the skin weights and the pose reconstruction data of the K associated skeletal components may be considered. This reduces a calculation amount and complexity of vertex calculation, and improves efficiency of animation generation. In some embodiments, the associated skeletal components may not be filtered, and for each vertex, a vertex position is directly recalculated by using the skin weights and the pose reconstruction data of the N skeletal components. Impact of all skeletal components on each vertex can be fully considered, to improve fineness of animation reconstruction.

310: The terminal obtains animation data of the avatar through synthesis based on an appearance resource of the avatar and the vertex position.

The appearance resource is configured for controlling an external representation of the avatar. For example, the appearance resource includes but are not limited to hair, skin, eyes, clothing, ornaments, effects, and the like.

The animation data represents that the avatar wears the appearance resource, presents the facial expression, and performs the body motion.

In some embodiments, the appearance resource of the avatar is queried based on the avatar ID of the avatar, and the found appearance resource is synthesized with the skeletal skin to obtain the animation data of the avatar. The animation data is rendered, and the animation data is visually displayed, so that the avatar wears the appearance resource of the avatar and presents a body motion and a facial expression obtained by simulating the physical object. A vertex position of each vertex in the skeletal skin is recalculated in the manner provided in operation 309.

In some embodiments, the GPU rendering pipeline is driven, based on a skeletal skin obtained by recalculating the vertex position and the appearance resource of the avatar, to perform a series of rendering processes such as vertex shading, rasterization, and pixel shading on the skeletal skin. Finally, the animation data of the avatar can be visually displayed, the animation data of the avatar is drawn on a display of the terminal, to display the animation data of the avatar. During real-time animation generation, provided that each animation frame of the avatar is displayed frame by frame, an animation of the avatar can be played, to implement real-time and dynamic animation driving.

In some embodiments, an RHI thread is created on the terminal. The appearance resource of the avatar and the skeletal skin obtained through deformation are submitted to the RHI thread. Then the RHI thread executes a DC command in a graphics API, to drive the GPU rendering pipeline to render the avatar to obtain an animation frame of the avatar.

A GPU rendering process for any animation frame is described below. The GPU rendering pipeline involves a VS, a rasterizer, and a PS. The VS is a rendering pipeline for performing calculation on a mesh vertex. The rasterizer is a rendering pipeline for assembling a result output by the VS into a triangular mesh and rasterizing the triangular mesh into discrete pixels based on a configuration. The PS is a rendering pipeline for performing shading calculation and pixel shading on each discrete pixel obtained through rasterization.

For each vertex in the mesh data, the motion data and the expression data control a vertex position. Posture information like a rotation angle may also affect a depth value of the vertex, and the appearance resource affects a color value and a depth value of the vertex. A color and a depth in a frame buffer are cleared. Then a depth of each vertex in the skeletal skin is written to a Z-buffer by using the VS. A depth value of each vertex is written to the Z-buffer. A depth sorting process is further involved herein. The depth sorting affects transparency and deals with some display effects such as occlusion or semi-transparency. Then rasterization is performed by using the rasterizer. Then a color of each discrete pixel is written to a color buffer by using the PS. A pixel value of each pixel is written to the color buffer. The pixel value of each pixel is obtained by integrating color values of vertices located at the pixel. Transparency of the vertices may be considered during the color value integration. Finally, an animation frame of the avatar can be output on the display of the terminal. Illumination calculation is involved in the vertex shading stage. An illumination model is determined based on the avatar or a rendering engine.

The frame buffer is configured to store data of all pixels in a current animation frame. The frame buffer includes a Z-buffer and a color buffer. The Z-buffer is a depth buffer in the frame buffer, and is configured to store a depth value of each pixel in the current animation frame. The color buffer is configured to store a color value of each pixel in the current animation frame.

In operations 307 to 310, some embodiments of obtaining the animation data of the avatar through synthesis based on the appearance resource of the avatar, the motion data, and the expression data is provided. The animation data of the avatar can be obtained through simulation based on the video data of the physical object, and conforms to the appearance resource that the avatar may wear.

When a video data stream is obtained in operation 301, the skeletal posture information and the facial posture information of the physical object are extracted from each video frame in operation 304. In operation 305, per-frame 3D skeletal reconstruction is performed to obtain motion data of the avatar in each animation frame. In operation 306, per-frame 3D facial reconstruction is performed to obtain expression data of the avatar in each animation frame. In operation 309, a vertex position of each vertex in the skeletal skin is recalculated in a per-frame manner. In operation 310, animation data of the avatar in each animation frame can be simulated in a per-frame manner. When the video data includes a plurality of video frames, the animation data includes a plurality of animation frames. Each animation frame is associated with one video frame, and a body motion and a facial expression of the avatar in the animation frame match a body motion and a facial expression of the physical object in the video frame. According to some embodiments, a body motion and a facial expression of the avatar can be consistent with those of the physical object in each frame, to optimize rendering effects of the avatar.

All of the foregoing technical solutions can be combined in any manner to form some embodiments. Details are not described herein.

According to the method provided in some embodiments, a body posture and an expression posture presented by a physical object in a planar coordinate system are extracted based on video data of the physical object. Then 3D reconstruction is performed on the physical object to obtain a body motion and a facial expression presented by an avatar in a spatial coordinate system. Then animation data of the avatar is obtained through synthesis based on an appearance resource of the avatar. The avatar can simulate the body motion and the facial expression of the physical object under driving by the video data. This animation generation process can be popularized in general scenarios such as livestreaming and gaming without relying on an expensive motion capture device. An animation can be reconstructed in real time, to meet a high requirement for real-time performance, and achieve a low delay of animation generation and high efficiency of animation generation.

Because animation rendering does not rely on a skeletal animation or a native digital human system of UE4, a synthetic avatar animation is not limited to several preset motion types, and stiffness and unsmoothness can be avoided during animation presentation. Animation control on the avatar can be implemented vertex by vertex. Reconstruction precision of a body motion and a facial expression of the avatar is accurate to a vertex in the mesh data of the avatar. The avatar can be controlled to precisely simulate a body motion and a facial expression of the physical object at high precision, to improve precision of animation generation for the avatar, achieve high flexibility and controllability, and optimize animation effects of the avatar.

How to drive real-time animation generation for an avatar based on the UE4 engine is described below by using an example in which a USB external camera captures a video data stream.

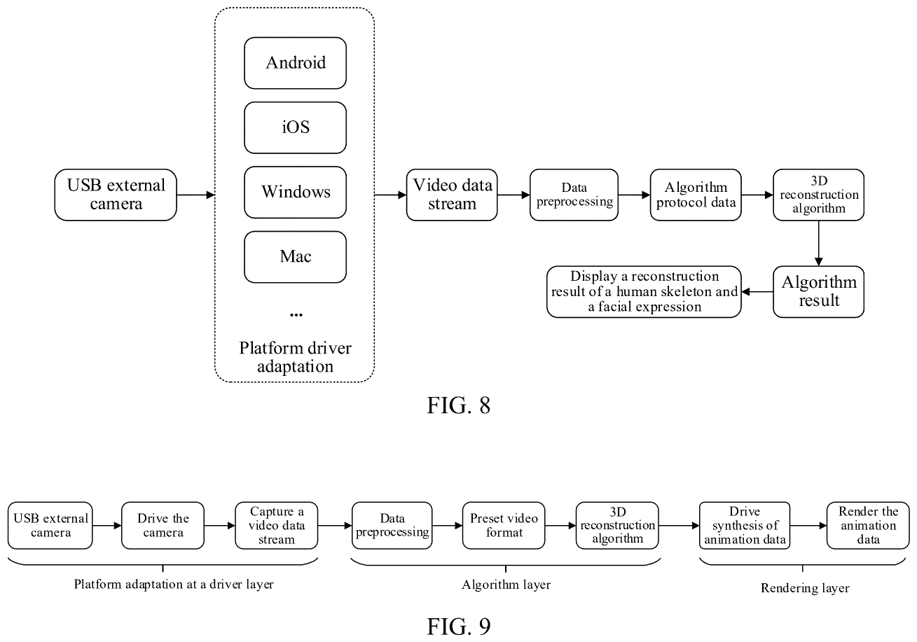

FIG. 8 is a flowchart of a principle of an animation generation solution according to some embodiments. As shown in FIG. 8, a USB external camera is connected to terminals based on different platforms, and driver adaptation is performed between the terminals based on different platforms and the USB external camera at a platform layer, to complete a communication connection between the USB external camera and the terminals. Then the UE4 may invoke the USB external camera in a form of a plug-in, to obtain a captured video data stream. Then the UE4 performs data preprocessing (for example, video format conversion) on the video data stream to obtain a video data stream in a preset video format (referred to as algorithm protocol data for short). The video format conversion may be accelerated by using asynchronous threads or GPU hardware. Then a 3D reconstruction algorithm is integrated into the UE4 in a form of a plug-in. The algorithm protocol data is input to the 3D reconstruction algorithm to obtain pose reconstruction data of each skeletal component. Each piece of pose reconstruction data includes one piece of displacement reconstruction information and one piece of rotation reconstruction information. Position reconstruction data of all skeletal components is collectively referred to as an algorithm result. Then the algorithm result is input to an animation blueprint of an avatar in the UE4, to control a pose change of a skeletal component of the avatar, and further affect a vertex position of a vertex in a skeletal skin. Each recalculated vertex position affects animation data of the avatar, to render the animation data of the avatar, and visually display an appearance resource, a body motion, and a facial expression of the avatar, display a reconstruction result of a human skeleton and a facial expression of the avatar.

FIG. 9 is a diagram of a logical principle of an animation generation solution according to some embodiments. As shown in FIG. 9, platform adaptation is implemented at a driver layer. A terminal can detect a connection status of a USB external camera, and set a shooting parameter, for example, a capture frame rate or a resolution, of the USB external camera, so that the terminal can smoothly drive the USB external camera to capture a video data stream in real time. At an algorithm layer, data preprocessing is performed on the video data stream captured by the USB external camera, the video data stream is converted into a video data stream that is in a preset video format and that adapts to a 3D reconstruction algorithm, posture information of a physical object is extracted from the video data stream in the preset video format, and then 3D reconstruction is performed to obtain motion data and expression data of an avatar. At a rendering layer, synthesis of animation data of the avatar is driven based on the motion data and the expression data of the avatar and an appearance resource of the avatar, and the synthetic animation data is rendered, so that a body motion and a facial expression of the avatar in a final rendering result is highly similar to a body motion and a facial expression made by the physical object. High-quality animation rendering for an avatar can be implemented in any scenario with a requirement for high real-time performance.

In the foregoing animation generation solution, the video data stream is captured by using the USB external camera. The USB external camera has good compatibility and can adapt to a terminal based on any platform. The USB external camera can adapt to various types of terminals, such as a mobile phone and a personal computer, and can further adapt to display devices with built-in cameras, such as a display in a conference room, a projector, and a display at a shopping mall, to cover more applicable general scenarios, so that real-time animation rendering for an avatar such as a digital human is no longer limited to professional film and television production scenarios. A series of processing links of capturing video data by using the USB external camera, reconstructing motion data and expression data by using an algorithm, and driving an avatar to simulate a behavior of a real person are streamlined in the UE4, so that application scenarios of avatars are expanded, and a high-quality avatar can be rendered and driven for various display devices. Provided that a terminal supports the UE4, a user can use the solution out of the box. Costs of use are low, and cross-platform use is supported. This greatly improves efficiency of animation generation, reduces a technical threshold and synthesis costs of animation generation, and improves user experience.

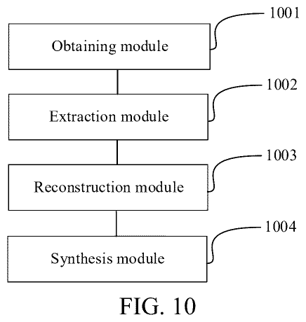

FIG. 10 is a schematic diagram of a structure of an animation generation apparatus for an avatar according to some embodiments. As shown in FIG. 10, the apparatus includes: an obtaining module 1001, configured to obtain video data of a physical object; an extraction module 1002, configured to extract posture information of the physical object based on the video data, the posture information representing a body posture and an expression posture that are presented by the physical object in the video data; a reconstruction module 1003, configured to perform 3D reconstruction on the physical object based on the posture information to obtain motion data and expression data of an avatar, the motion data representing a body motion of the avatar that is obtained through reconstruction based on the body posture, and the expression data representing a facial expression of the avatar that is obtained through reconstruction based on the expression posture; and a synthesis module 1004, configured to obtain animation data of the avatar through synthesis based on an appearance resource of the avatar, the motion data, and the expression data, the animation data representing that the avatar wears the appearance resource, presents the facial expression, and performs the body motion.

According to the apparatus provided in some embodiments, a body posture and an expression posture presented by a physical object in a planar coordinate system are extracted based on video data of the physical object. Then 3D reconstruction is performed on the physical object to obtain a body motion and a facial expression presented by an avatar in a spatial coordinate system. Then animation data of the avatar is obtained through synthesis based on an appearance resource of the avatar. The avatar can simulate the body motion and the facial expression of the physical object under driving by the video data. This animation generation process can be popularized in general scenarios such as livestreaming and gaming without relying on an expensive motion capture device. An animation can be reconstructed in real time, to meet a high requirement for real-time performance, and achieve a low delay of animation generation and high efficiency of animation generation.

In some embodiments, the extraction module 1002 is configured to: determine a skeletal key point and a facial key point of the physical object; extract skeletal posture information of the skeletal key point and facial posture information of the facial key point based on the video data, the skeletal posture information representing a 2D pose of the skeletal key point, and the facial posture information representing a 2D pose of the facial key point; and form the posture information of the physical object by using the skeletal posture information and the facial posture information.

In some embodiments, the posture information includes the skeletal posture information and the facial posture information, and the reconstruction module 1003 is configured to: reconstruct motion data of a skeletal key point of the avatar based on the skeletal posture information, the motion data including a 3D pose of the skeletal key point; and reconstruct expression data of a facial key point of the avatar based on the facial posture information, the expression data including a 3D pose of the facial key point.

In some embodiments, based on the apparatus composition in FIG. 10, the synthesis module 1004 includes: a weight determining unit, configured to determine, for each vertex of a skeletal skin of the avatar, a skin weight of each skeletal component of the avatar relative to the vertex, the skin weight representing a degree of impact of the skeletal component on the vertex; a pose determining unit, configured to determine pose reconstruction data of each skeletal component based on the motion data and the expression data; a position determining unit, configured to determine a vertex position of each vertex based on the pose reconstruction data and the skin weight; and an animation synthesis unit, configured to obtain the animation data through synthesis based on the appearance resource and the vertex position.

In some embodiments, based on the apparatus composition in FIG. 10, the apparatus further includes: an exporting module, configured to export mesh data of the avatar based on a 3D model of the avatar; and a binding module, configured to bind, to each skeletal component of the 3D model, mesh data of a part associated with the skeletal component, to obtain the skeletal skin of the avatar.

In some embodiments, the pose determining unit is configured to: determine a reconstructed key point included in each skeletal component of the avatar; when the reconstructed key point includes a skeletal key point, determine a 3D pose of the reconstructed key point based on the motion data; when the reconstructed key point includes a facial key point, determine a 3D pose of the reconstructed key point based on the expression data; and determine 3D poses of all reconstructed key points included in the skeletal component as the pose reconstruction data of the skeletal component.

In some embodiments, the position determining unit is configured to: for each vertex of the skeletal skin, determine an associated skeletal component of the vertex from skeletal components based on skin weights of the skeletal components relative to the vertex; and determine a vertex position of the vertex based on pose reconstruction data of the associated skeletal component and the skin weight.

In some embodiments, based on the apparatus composition in FIG. 10, the obtaining module 1001 includes: a shooting unit, configured to capture the video data of the physical object based on an external camera; and a conversion unit, configured to convert the video data from a video format supported by the external camera into a preset video format, the preset video format being a format supporting 3D reconstruction of the physical object.

In some embodiments, the conversion unit is configured to perform at least one of the following operations: starting a sub-thread configured for format conversion, and converting the video data from the video format supported by the external camera into the preset video format by using the sub-thread; or invoking a DC command of a GPU, and converting the video data from the video format supported by the external camera into the preset video format by using the GPU.

In some embodiments, when the video data includes a plurality of video frames, the animation data includes a plurality of animation frames. Each animation frame is associated with one video frame, and a body motion and a facial expression of the avatar in the animation frame match a body motion and a facial expression of the physical object in the video frame.

All of the foregoing technical solutions can be combined in any manner to form some embodiments. Details are not described herein.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

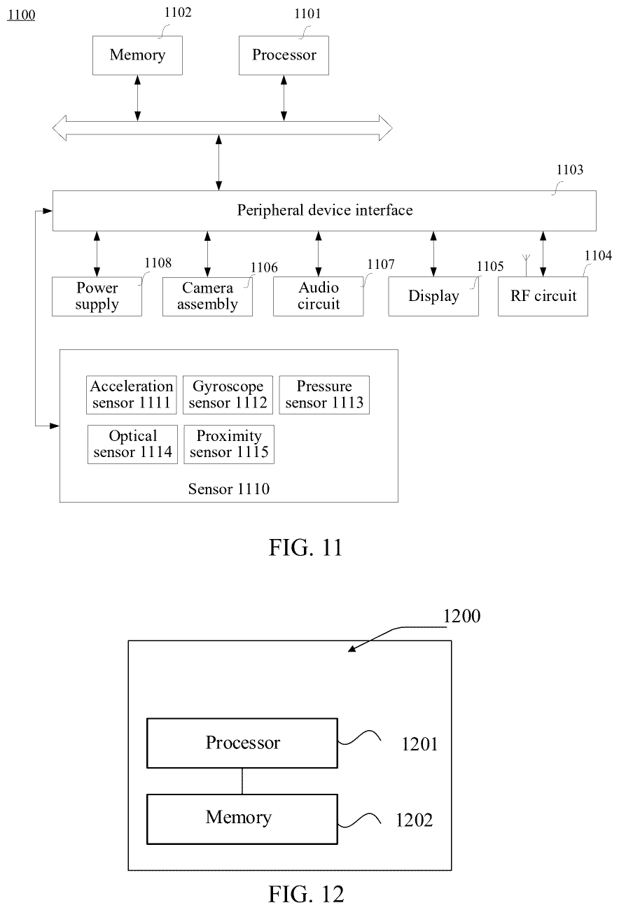

FIG. 11 is a schematic diagram of a structure of an electronic device according to some embodiments. As shown in FIG. 11, descriptions are provided by using an example in which the electronic device is a terminal. The terminal 1100 may include a processor 1101 and a memory 1102.

In some embodiments, the processor 1101 includes one or more processing cores, for example, a 4-core processor or an 8-core processor. In some embodiments, the processor 1101 may be implemented in at least one hardware form of a digital signal processor (DSP), a field programmable gate array (FPGA), or a programmable logic array (PLA). In some embodiments, the processor 1101 includes a main processor and a coprocessor. The main processor is configured to process data in an active state, also referred to as a CPU. The coprocessor is a low-power processor configured to process data in a standby state. In some embodiments, the processor 1101 may be integrated with a GPU. The GPU is configured to render and draw content that may be displayed on a display. In some embodiments, the processor 1101 further includes an AI processor. The AI processor is configured to process computing operations related to machine learning.

In some embodiments, the memory 1102 includes one or more computer-readable storage media. In some embodiments, the computer-readable storage medium is non-transient. In some embodiments, the memory 1102 may further include a high-speed RAM and a non-volatile memory, for example, one or more disk storage devices or flash storage devices. In some embodiments, the non-transient computer-readable storage medium in the memory 1102 is configured to store at least one instruction, and the at least one instruction is configured to be executed by the processor 1101 to implement the animation generation method for an avatar in some embodiments.

In some embodiments, the terminal 1100 further includes a peripheral device interface 1103 and at least one peripheral device. The processor 1101, the memory 1102, and the peripheral device interface 1103 can be connected through a bus or a signal cable. Each peripheral device can be connected to the peripheral device interface 1103 through a bus, a signal cable, or a circuit board. The peripheral device includes at least one of a radio frequency (RF) circuit 1104, a display 1105, a camera assembly 1106, an audio circuit 1107, and a power supply 1108.

The peripheral device interface 1103 may be configured to connect the at least one peripheral related to input/output (I/O) to the processor 1101 and the memory 1102. In some embodiments, the processor 1101, the memory 1102, and the peripheral device interface 1103 are integrated on a same chip or circuit board. In some embodiments, any one or two of the processor 1101, the memory 1102, and the peripheral device interface 1103 is/are implemented on a separate chip or circuit board. This is not limited.

The RF circuit 1104 is configured to receive and transmit an RF signal, also referred to as an electromagnetic signal. The RF circuit 1104 communicates with a communication network and other communication devices through the electromagnetic signal. The RF circuit 1104 converts an electrical signal into an electromagnetic signal for transmission, or converts a received electromagnetic signal into an electrical signal. In some embodiments, the RF circuit 1104 includes an antenna system, an RF transceiver, one or more amplifiers, a tuner, an oscillator, a DSP, a codec chipset, a subscriber identity module card, and the like. In some embodiments, the RF circuit 1104 communicates with another terminal through at least one wireless communication protocol. The wireless communication protocol includes but is not limited to a metropolitan area network, various generations of mobile communication networks (2G, 3G, 4G, and 5G), a wireless local area network, and/or a wireless fidelity (Wi-Fi) network. In some embodiments, the RF circuit 1104 further includes a circuit related to near field communication (NFC). The disclosure is not limited thereto.

The display 1105 is configured to display a user interface (UI). In some embodiments, the UI includes a graph, text, an icon, a video, and any combination thereof. When the display 1105 is a touch display, the display 1105 is further capable of capturing a touch signal on or above a surface of the display 1105. The touch signal may be input to the processor 1101 for processing as a control signal. The display 1105 is further configured to provide a virtual button and/or a virtual keyboard, which are/is also referred to as a soft button and/or a soft keyboard. In some embodiments, there is one display 1105 disposed on a front panel of the terminal 1100. In some embodiments, there are at least two displays 1105 respectively disposed on different surfaces of the terminal 1100 or designed in a folded form. In some embodiments, the display 1105 is a flexible display disposed on a curved surface or a folded surface of the terminal 1100. In some embodiments, the display 1105 may be even disposed in a non-rectangular irregular pattern, for example, a special-shaped screen. In some embodiments, the display 1105 is made of a liquid crystal display (LCD), an organic light-emitting diode (OLED), or other materials.

The camera assembly 1106 is configured to capture images or videos. In some embodiments, the camera assembly 1106 includes a front-facing camera and a rear-facing camera. The front-facing camera is disposed on the front panel of the terminal, and the rear-facing camera is disposed on a rear side of the terminal. In some embodiments, there are at least two rear-facing cameras, each of which is any one of a main camera, a depth-of-field camera, a wide-angle camera, and a telephoto camera, to implement a background blur function through fusion of the main camera and the depth-of-field camera, and implement a panoramic photographing function and a VR photographing function or other fusion photographing functions through fusion of the main camera and the wide-angle camera. In some embodiments, the camera assembly 1106 further includes a flash. In some embodiments, the flash is a mono color temperature flash or a double color temperature flash. The double color temperature flash is a combination of a warm light flash and a cold light flash, and is configured for light compensation under different color temperatures.

In some embodiments, the audio circuit 1107 includes a microphone and a speaker. The microphone is configured to capture sound waves of a user and an environment, and convert the sound waves into an electrical signal to input to the processor 1101 for processing, or input to the RF circuit 1104 for implementing voice communication. To capture stereo or reduce noise, there are a plurality of microphones respectively disposed at different parts of the terminal 1100. In some embodiments, the microphone is an array microphone or an omni-directional capture microphone. The speaker is configured to convert an electrical signal from the processor 1101 or the RF circuit 1104 into a sound wave. In some embodiments, the speaker is a film speaker or a piezoelectric ceramic speaker. When the speaker is a piezoelectric ceramic speaker, the speaker not only can convert an electrical signal into a sound wave audible to a human being, but also can convert an electrical signal into a sound wave inaudible to a human being, for ranging and other purposes. In some embodiments, the audio circuit 1107 further includes a headset jack.

The power supply 1108 is configured to supply power to components in the terminal 1100. In some embodiments, the power supply 1108 may be an alternating current power supply, a direct current power supply, a disposable battery, or a rechargeable battery. When the power supply 1108 includes a rechargeable battery, the rechargeable battery supports wired charging or wireless charging. The rechargeable battery is further configured to support a fast charge technology.

In some embodiments, the terminal 1100 further includes one or more sensors 1110. The one or more sensors 1110 include but are not limited to an acceleration sensor 1111, a gyroscope sensor 1112, a pressure sensor 1113, an optical sensor 1114, and a proximity sensor 1115.

In some embodiments, the acceleration sensor 1111 detects a magnitude of an acceleration on three coordinate axes of a coordinate system established based on the terminal 1100. For example, the acceleration sensor 1111 is configured to detect components of a gravity acceleration on the three coordinate axes. In some embodiments, the processor 1101 controls, based on a gravity acceleration signal captured by the acceleration sensor 1111, the display 1105 to display the UI in a landscape view or a portrait view. The acceleration sensor 1111 is further configured to capture motion data of a game or a user.

In some embodiments, the gyroscope sensor 1112 detects a body direction and a rotation angle of the terminal 1100. The gyroscope sensor 1112 cooperates with the acceleration sensor 1111 to capture a 3D motion of the user on the terminal 1100. The processor 1101 implements the following functions based on data captured by the gyroscope sensor 1112: motion sensing (for example, changing the UI based on a tilt operation of the user), image stabilization at shooting, game control, and inertial navigation.

In some embodiments, the pressure sensor 1113 is disposed at a side bezel of the terminal 1100 and/or a lower layer of the display 1105. When the pressure sensor 1113 is disposed at the side bezel of the terminal 1100, a holding signal of the user on the terminal 1100 can be detected. The processor 1101 performs left and right hand recognition or a quick operation based on the holding signal captured by the pressure sensor 1113. When the pressure sensor 1113 is disposed at the lower layer of the display 1105, the processor 1101 controls an operable control on the UI based on a pressure operation performed by the user on the display 1105. The operable control includes at least one of a button control, a scroll-bar control, an icon control, and a menu control.

The optical sensor 1114 is configured to capture ambient light intensity. In some embodiments, the processor 1101 controls display brightness of the display 1105 based on the ambient light intensity captured by the optical sensor 1114. When the ambient light intensity is high, the display brightness of the display 1105 is increased; or when the ambient light intensity is low, the display brightness of the display 1105 is decreased. In some embodiments, the processor 1101 further dynamically adjusts a shooting parameter of the camera assembly 1106 based on the ambient light intensity captured by the optical sensor 1114.

The proximity sensor 1115, also referred to as a distance sensor, may be disposed on the front panel of the terminal 1100. The proximity sensor 1115 is configured to capture a distance between a user and a front surface of the terminal 1100. In some embodiments, when the proximity sensor 1115 detects that the distance between the user and the front surface of the terminal 1100 gradually decreases, the processor 1101 controls the display 1105 to switch from a screen-on state to a screen-off state; or when the proximity sensor 1115 detects that the distance between the user and the front surface of the terminal 1100 gradually increases, the processor 1101 controls the display 1105 to switch from a screen-off state to a screen-on state.

A person skilled in the art can understand that the structure shown in FIG. 11 does not constitute a limitation on the terminal 1100, and the terminal can include more or fewer components than those shown in the figure, or some components may be combined, or different component layouts may be used.

FIG. 12 is a schematic diagram of a structure of another electronic device according to some embodiments. As shown in FIG. 12, for example, the electronic device is a server. The server 1200 may vary greatly due to different configurations or performance. The server 1200 includes one or more CPUs 1201 and one or more memories 1202. The memory 1202 has at least one computer-executable instruction stored therein. The at least one computer-executable instruction is loaded and executed by the one or more processors 1201 to implement the animation generation method for an avatar in some embodiments. In some embodiments, the server 1200 further includes components such as a wired or wireless network interface, a keyboard, and an I/O interface for input and output. The server 1200 further includes another component for implementing a device function. Details are not described herein.

In some embodiments, a computer-readable storage medium, for example, a memory including at least one computer-executable instruction, is further provided, and the at least one computer-executable instruction may be executed by a processor in an electronic device to complete the animation generation method for an avatar in some embodiments. For example, the computer-readable storage medium includes a read-only memory (ROM), a RAM, a compact disc read-only memory (CD-ROM), a magnetic tape, a floppy disk, and an optical data storage device.

In some embodiments, a computer program product is further provided, including one or more computer-executable instructions, and the one or more computer-executable instructions is/are stored in a computer-readable storage medium. One or more processors of an electronic device can read the one or more computer-executable instructions from the computer-readable storage medium, and the one or more processors executes/execute the one or more computer-executable instructions, to enable the electronic device to perform the foregoing animation generation method for an avatar.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An avatar animation generation method, performed by an electronic device, comprising:
obtaining video data of a physical object;
extracting posture information of the physical object based on the video data, wherein the posture information indicates a body posture and an expression posture presented by the physical object in the video data;
performing 3D reconstruction on the physical object based on the posture information to obtain motion data representing a body motion of an avatar and expression data representing a facial expression of the avatar, wherein the motion data is obtained through reconstruction based on the body posture, and wherein the expression data is obtained through reconstruction based on the expression posture; and
obtaining animation data of the avatar through synthesis based on an appearance resource of the avatar, the motion data, and the expression data, wherein the animation data indicates that the avatar wears the appearance resource, presents the facial expression, and performs the body motion.

2. The avatar animation generation method according to claim 1, wherein the extracting the posture information comprises:
determining a skeletal key point and a facial key point of the physical object;
extracting, based on the video data, skeletal posture information of the skeletal key point and facial posture information of the facial key point, wherein the skeletal posture information indicates a 2D pose of the skeletal key point, and the facial posture information indicates a 2D pose of the facial key point; and
forming the posture information based on the skeletal posture information and the facial posture information.

3. The avatar animation generation method according to claim 2, wherein the posture information comprises the skeletal posture information and the facial posture information, and wherein the performing the 3D reconstruction comprises:
reconstructing first motion data of a first skeletal key point of the avatar based on the skeletal posture information, wherein the first motion data comprises a first 3D pose of the first skeletal key point; and
reconstructing first expression data of a first facial key point of the avatar based on the facial posture information, wherein the first expression data comprises a second 3D pose of the first facial key point.

4. The avatar animation generation method according to claim 1, wherein the obtaining the animation data comprises:
determining, for at least one vertex of a skeletal skin of the avatar, a skin weight of at least one skeletal component of the avatar relative to the at least one vertex, the skin weight representing a degree of impact of the at least one skeletal component on the at least one vertex;
determining pose reconstruction data of the at least one skeletal component based on the motion data and the expression data;
determining at least one vertex position of the at least one vertex based on the pose reconstruction data and the skin weight; and
obtaining the animation data through synthesis based on the appearance resource and the at least one vertex position.

5. The avatar animation generation method according to claim 4, further comprising:
exporting mesh data of the avatar based on a 3D model of the avatar; and
binding, to at least one first skeletal component of the 3D model, mesh data of a part associated with the at least one first skeletal component, to obtain the skeletal skin.

6. The avatar animation generation method according to claim 4, wherein the determining the pose reconstruction data comprises:
determining a reconstructed key point comprised in a skeletal component of the avatar;
based on the reconstructed key point comprising a skeletal key point, determining a first 3D pose of the reconstructed key point based on the motion data;
based on the reconstructed key point comprising a facial key point, determining a second 3D pose of the reconstructed key point based on the expression data; and
determining a plurality of 3D poses of a plurality of reconstructed key points in the skeletal component as the pose reconstruction data.

7. The avatar animation generation method according to claim 4, wherein the determining the at least one vertex position comprises:
for a vertex of the skeletal skin, determining a corresponding skeletal component of the vertex from a plurality of skeletal components based on a plurality of skin weights of the plurality of skeletal components relative to the vertex; and
determining a vertex position of the vertex based on first pose reconstruction data of the corresponding skeletal component and the skin weight.

8. The avatar animation generation method according to claim 1, wherein the obtaining the video data comprises:
capturing the video data via an external camera; and
converting the video data from a first video format used by the external camera into a second video format enabling the 3D reconstruction of the physical object.

9. The avatar animation generation method according to claim 8, wherein the converting the video data comprises:
performing at least one of:
starting a sub-thread for format conversion, and converting the video data from the first video format into the second video format via the sub-thread; or
invoking a DC command of a GPU, and converting the video data from the first video format into the second video format via the GPU.

10. The avatar animation generation method according to claim 1, wherein based on the video data comprising a plurality of video frames, the animation data comprises a plurality of corresponding animation frames, and
wherein an animation frame comprises:
a first body motion of the avatar corresponding to a second body motion of the physical object in a corresponding video frame; and
a first facial expression of the avatar corresponding to a second facial expression of the physical object in the corresponding video frame.

11. An avatar animation generation apparatus comprising:
at least one memory configured to store computer program code; and
at least one processor configured to read the program code and operate as instructed by the program code, the program code comprising:
obtaining code configured to cause at least one of the at least one processor to obtain video data of a physical object;
extraction code configured to cause at least one of the at least one processor to extract posture information of the physical object based on the video data, wherein the posture information indicates a body posture and an expression posture presented by the physical object in the video data;
reconstruction code configured to cause at least one of the at least one processor to perform 3D reconstruction on the physical object based on the posture information to obtain motion data representing a body motion of an avatar and expression data representing a facial expression of the avatar, wherein the motion data is obtained through reconstruction based on the body posture, and wherein the expression data is obtained through reconstruction based on the expression posture; and
synthesis code configured to cause at least one of the at least one processor to obtain animation data of the avatar through synthesis based on an appearance resource of the avatar, the motion data, and the expression data, wherein the animation data indicates that the avatar wears the appearance resource, presents the facial expression, and performs the body motion.

12. The avatar animation generation apparatus according to claim 11, wherein the extraction code is configured to cause at least one of the at least one processor to:
determine a skeletal key point and a facial key point of the physical object;
extract, based on the video data, skeletal posture information of the skeletal key point and facial posture information of the facial key point, wherein the skeletal posture information indicates a 2D pose of the skeletal key point, and the facial posture information indicates a 2D pose of the facial key point; and
form the posture information based on the skeletal posture information and the facial posture information.

13. The avatar animation generation apparatus according to claim 12, wherein the posture information comprises the skeletal posture information and the facial posture information, and wherein the reconstruction code is configured to cause at least one of the at least one processor to:
reconstruct first motion data of a first skeletal key point of the avatar based on the skeletal posture information, wherein the first motion data comprises a first 3D pose of the first skeletal key point; and
reconstruct first expression data of a first facial key point of the avatar based on the facial posture information, wherein the first expression data comprises a second 3D pose of the first facial key point.

14. The avatar animation generation apparatus according to claim 11, wherein the synthesis code configured to cause at least one of the at least one processor to:
determining, for at least one vertex of a skeletal skin of the avatar, a skin weight of at least one skeletal component of the avatar relative to the at least one vertex, the skin weight representing a degree of impact of the at least one skeletal component on the at least one vertex;
determining pose reconstruction data of the at least one skeletal component based on the motion data and the expression data;
determining at least one vertex position of the at least one vertex based on the pose reconstruction data and the skin weight; and
obtaining the animation data through synthesis based on the appearance resource and the at least one vertex position.

15. The avatar animation generation apparatus according to claim 14, wherein the synthesis code is further configured to cause at least one of the at least one processor to:
export mesh data of the avatar based on a 3D model of the avatar; and
bind, to at least one first skeletal component of the 3D model, mesh data of a part associated with the at least one first skeletal component, to obtain the skeletal skin.

16. The avatar animation generation apparatus according to claim 14, wherein the synthesis code configured to cause at least one of the at least one processor to:
determine a reconstructed key point comprised in a skeletal component of the avatar;
based on the reconstructed key point comprising a skeletal key point, determine a first 3D pose of the reconstructed key point based on the motion data;
based on the reconstructed key point comprising a facial key point, determine a second 3D pose of the reconstructed key point based on the expression data; and
determine a plurality of 3D poses of a plurality of reconstructed key points in the skeletal component as the pose reconstruction data.

17. The avatar animation generation apparatus according to claim 14, wherein the synthesis code configured to cause at least one of the at least one processor to:
for a vertex of the skeletal skin, determine a corresponding skeletal component of the vertex from a plurality of skeletal components based on a plurality of skin weights of the plurality of skeletal components relative to the vertex; and
determine a vertex position of the vertex based on first pose reconstruction data of the corresponding skeletal component and the skin weight.

18. The avatar animation generation apparatus according to claim 11, wherein the obtaining code configured to cause at least one of the at least one processor to:
capture the video data via an external camera; and
convert the video data from a first video format used by the external camera into a second video format enabling the 3D reconstruction of the physical object.

19. The avatar animation generation apparatus according to claim 18, wherein the obtaining code configured to cause at least one of the at least one processor to perform at least one of:
starting a sub-thread for format conversion, and converting the video data from the first video format into the second video format via the sub-thread; or
invoking a DC command of a GPU, and converting the video data from the first video format into the second video format via the GPU.

20. A non-transitory computer-readable storage medium, storing computer code which, when executed by at least one processor, causes the at least one processor to at least:
obtain video data of a physical object;
extract posture information of the physical object based on the video data, wherein the posture information indicates a body posture and an expression posture presented by the physical object in the video data;
perform 3D reconstruction on the physical object based on the posture information to obtain motion data representing a body motion of an avatar and expression data representing a facial expression of the avatar, wherein the motion data is obtained through reconstruction based on the body posture, and wherein the expression data is obtained through reconstruction based on the expression posture; and
obtain animation data of the avatar through synthesis based on an appearance resource of the avatar, the motion data, and the expression data, wherein the animation data indicates that the avatar wears the appearance resource, presents the facial expression, and performs the body motion.
